(19) United States
(12) Patent Application Publication
(10) Pub. No.: US 2014/0227437 A1
(43) Pub. Date: Aug. 14, 2014

(54) ACCOMMODATING INTRAOCULAR LENS

(71) Applicants: California Institute of Technology, Pasadena, CA (US); University of Southern California, Los Angeles, CA (US)

(72) Inventors: Charles DeBoer, Pasadena, CA (US); Yu-Chong Tai, Pasadena, CA (US); Mark Humayun, Glendale, CA (US); Wendian Shi, Monrovia, CA (US)

(73) Assignees: California Institute of Technology, Pasadena, CA (US); University of Southern California, Los Angeles, CA (US)

(21) Appl. No.: 14/256,845

(22) Filed: Apr. 18, 2014

Related U.S. Application Data
(63) Continuation-in-part of application No. 13/761,024, filed on Feb. 6, 2013, now Pat. No. 8,715,345.
Application No. 13/761,024 is a continuation-in-part of application No. 13/350,612, filed on Jan. 13, 2012.
(60) Provisional application No. 61/920,623, filed on Dec. 24, 2013.
(60) Provisional application No. 61/920,619, filed on Dec. 24, 2013.
(60) Provisional application No. 61/907,581, filed on Nov. 22, 2013.
(60) Provisional application No. 61/904,200, filed on Nov. 14, 2013.
(60) Provisional application No. 61/526,147, filed on Aug. 22, 2011.
(60) Provisional application No. 61/488,964, filed on May 23, 2011.

(51) Int. Cl. B29D 11/00

(52) U.S. Cl. CPC B29D 11/00009
USPC 427/162; 156/304.2

(57) ABSTRACT

Systems, devices, and methods are presented for a prosthetic injectable intraocular lens. The lenses can be made from silicone, fluorosilicone, and phenyl substituted silicone and be semipermeable to air. One or more silicone elastomeric patches located outside the optical path on the anterior side but away from the equator can be accessed by surgical needles in order to fill or adjust optically clear fluid within the lens. The fluid can be adjusted in order to set a base dioptric power of the lens and otherwise adjust a lens after its initial insertion. The elastomeric patches are sized so that they self-seal after a needle is withdrawn. A straight or stepped slit in the patch can allow a blunt needle to more easily access the interior of the lens.

### CROSS-REFERENCES TO RELATED APPLICATIONS

This application claims the benefit of U.S. Provisional Application No. 61/920,623, filed Dec. 24, 2013, U.S. Provisional Application No. 61/920,619, filed Dec. 24, 2013, U.S. Provisional Application No. 61/907,581, filed Nov. 22, 2013, and U.S. Provisional Application No. 61/904,200, filed Nov. 14, 2013, and this application is a continuation-in-part of U.S. application Ser. No. 13/761,024, filed Feb. 6, 2013, which is a continuation-in-part application of U.S. application Ser. No. 13/350,612, filed Jan. 13, 2012, which claims the benefit of U.S. Provisional Application No. 61/526,147, filed Aug. 22, 2011, and U.S. Provisional Application No. 61/488,964, filed May 23, 2011, which are hereby incorporated by reference in their entireties for all purposes.

### STATEMENT AS TO RIGHTS TO INVENTIONS MADE UNDER FEDERALLY SPONSORED RESEARCH OR DEVELOPMENT

This invention was made with government support under EEC0310723 awarded by the National Science Foundation. The government has certain rights in the invention.

### BACKGROUND

1. Field of the Art

Embodiments of the present invention generally relate to surgically implanted eye prostheses, in particular, to microfabricated, fluid-filled intraocular lens devices.

2. Description of the Related Art

### Surgical Procedure

An intraocular lens (IOL) can be used to replace a natural crystalline lens in human patients. Surgically replacing the crystalline lens typically includes making a main incision of approximately 2 to 4 millimeters (mm) in the periphery of the patient's cornea, cutting a 5.5 to 6 mm diameter circular hole in the eye's anterior capsule surrounding the lens, and removing the lens with phacoemulsification.

Because replacing the crystalline lens with an intraocular lens is an invasive procedure, this option is reserved for when vision is significantly impaired. Most commonly, it is used when the lens forms a cataract.

However, several factors are making this a less invasive procedure with faster recovery times. These include the trend of using smaller surgical instrumentation with a correspondingly smaller main incision to reduce postoperative recovery time and astigmatism. Furthermore, femtosecond pulse lasers are beginning to be used for lens/cataract removal, which makes the procedure safer, faster, and more accurate.

### Surgical Complications

The most common surgical complication of lens replacement is posterior capsular opacification (PCO), which occurs when residual lens epithelial cells move to the posterior portion of the capsule and proliferate. This makes the capsule hazy and creates visual disturbances. PCO is treated by externally using a neodymium-doped yttrium aluminium garnet (Nd:YAG) laser to remove a section of the posterior capsule. It may also be alleviated by cutting the posterior lens capsule with a femtosecond laser.

Intraocular lenses are often designed with a square edge to prevent lens epithelial cells from migrating to the posterior capsule, and therefore prevents PCO.

Similar to posterior capsular opacification, anterior capsular opacification can also cause contraction of the lens capsule and visual opacification.

### Accommodation and Presbyopia

“Accommodation” is where an eye changes optical power to focus on an object. This occurs from contraction of a ciliary muscle, which releases tension on the lens capsule. Upon release of this tension, the human lens naturally bulges out, increasing optical power.

Presbyopia is a clinical condition in which the eye can no longer focus on near objects. It is believed that this is a multifactorial process caused primarily by a loss of elasticity of the human lens. Therefore, replacing the human lens with an accommodating intraocular lens provides the capability to restore focusing ability and cure presbyopia.

### Existing Devices

Current intraocular lenses can be categorized into three categories: monofocal, multifocal, and accommodating.

Monofocal lenses provide a single focal distance. Therefore, patients with a monofocal intraocular lens can no longer focus their eyes. This makes it difficult to focus on near objects.

To alleviate this condition, multifocal intraocular lenses were developed. Multifocal intraocular lenses provide simultaneous focus at both near and far distances. However, because of the unique optical design, patients may have a loss of sharpness of vision even when glasses are used. Patients can also experience visual disturbances such as halos or glare.

Accommodating intraocular lenses use the natural focusing ability of the eye to change the power of the intraocular lens. There are many designs of accommodating intraocular lenses, including single optics that translate along the visual axis of the eye to focus, dual optics that move two lenses closer and further apart, and curvature-changing lenses that change focal power by changing the curvature of the lens.

### Future Market

Less invasive and faster surgical procedures in conjunction with accommodating intraocular lenses may allow intraocular lenses to be used for wider applications than are currently used today. This includes treatments for cataracts as well as presbyopia. This is a much larger market because almost all individuals undergo presbyopia around the fourth decade of life.

Further, other implantable polymeric cavities have been deployed for many uses including breast implants, which are often filled with saline or silicone gel; tissue spacers for moving tissue planes, e.g., to move adjacent tissues away from areas treated with radiation therapy; drug reservoirs; inflatable scleral buckles, testicular implants; and gastric sleeves. Manufacturing these devices has proven challenging, however. Spin-molding, for example, can cause non-uniformity because the molded material tends to move away from the axis of rotation, leaving the outer regions of the cavity thicker than the central portions. Moreover, because material flows from the center to the outside of the mold, this technique is unsuitable for generating complex shapes such as grooves, bridging portions, or areas folding back on themselves.

### BRIEF SUMMARY

Systems, devices, and methods of the present application are related to an intraocular lens having one or more valve areas consisting of an elastomeric patch. The elastomeric patch is sized such that it self-seals after a needle puncture, such that the optically transparent fluid within the intraocular lens can be injected or withdrawn in order to adjust a lens after implantation. A slit can be manufactured into the patch that is sized for self-closing and allows standard gauge surgical needles to pass through. The patch can include a stepped area for additional closing power. The patch can be brightly colored so that it is more easily found by a surgeon. In another design, a wagon-wheel shaped valve with a plurality of wedge-shaped openings can be encapsulated in the walls of the lens. The center of the wagon wheel or each of the wedge-shaped openings can be pierced by a needle.

An intraocular lens can have a shape-memory alloy whose curvature can be wirelessly adjusted without later surgery. Air bubble-capture traps can be manufactured into the internal side of the lens in order to trap bubbles and hold them until a surgeon can remove them. A plurality of ports, such as the patches described above, can be placed so that multiple instruments can access the lens simultaneously. Markings on the side of the lens can indicate pressure or other stress in the lens.

Adhesive can be used to not only form a bond between an intraocular lens and the lens capsule but also placed to prevent cells from migrating to the optical center region of the lens and to increase adhesion and mechanical coupling to the natural lens.

Some embodiments of the present application are related to an intraocular lens apparatus. The lens apparatus includes a biocompatible polymer balloon fillable with an optically clear medium, the balloon configured for insertion into a capsular bag of an eye, and an elastomeric patch intimately attached to the balloon, the elastomeric membrane having a thickness sufficient self-sealing of needle punctures at nominal lens pressures.

The patch can have a thickness between 25 μm and 2000 μm. In some embodiments, the patch can have a thickness equal to or greater than 100 μm and or a thickness equal to or less than 700 μm, thereby being thin enough to avoid contact with a posterior iris when implanted in an eye. In some applications, the patch has a thickness between 160 μm and 350 μm, and in other application, the patch has a thickness between 150 μm and 250 μm.

The patch can be colored, and it can have a pre-formed slit (straight or with a stepped portion) adapted for a needle to pass through.

Some embodiments are related to an intraocular lens apparatus including a biocompatible polymer balloon fillable with an optically clear medium, the balloon configured for insertion into a capsular bag of an eye, and a shape memory alloy configured to be wirelessly modifiable by a remote source.

Some embodiments are related to an intraocular lens apparatus including a biocompatible polymer balloon fillable with an optically clear medium, the balloon configured for insertion into a capsular bag of an eye, and means for capturing air bubbles from inside the balloon, such as an out-pocket with a one-way valve and a port for admittance of a surgical instrument for removing air bubbles.

Some embodiments are related to an intraocular lens apparatus including a biocompatible polymer balloon, the balloon having a plurality of individually fillable compartments, each compartment fillable with an optically clear medium, the balloon configured for insertion into a capsular bag of an eye.

Some embodiments are related to an intraocular lens apparatus including a biocompatible polymer balloon fillable with an optically clear medium, the balloon configured for insertion into a capsular bag of an eye, and a plurality of ports attached to the balloon, the ports facilitating simultaneous entry into the balloon by a plurality of surgical injection devices.

Some embodiments are related to an intraocular lens apparatus including a biocompatible polymer balloon fillable with an optically clear medium, the balloon configured for insertion into a capsular bag of an eye, and a needle-pierceable port formed from a frame of material having a rigidity greater than that of the balloon, the frame encapsulated in place on a wall of the balloon by an envelope of polymer material affixed to the wall.

The frame can have a wagon-wheel configuration defining a plurality of wedge-shaped openings, each of which provides a needle-pierceable port. Alternately, the center of the wagon-wheel configuration can be pierced.

Some embodiments are related to an intraocular lens apparatus including a biocompatible polymer balloon fillable with an optically clear medium, the balloon configured for insertion into a capsular bag of an eye, the balloon having a plurality of circular or other pre-spaced markings thereon indicating an amount of flex and/or pressure within the balloon.

Some embodiments are related to a method of coupling an intraocular lens apparatus and a lens capsule. The method includes applying a circular annulus of adhesive, and implanting a lens apparatus such that the circular annulus of adhesive adheres the lens apparatus to a lens capsule, the circular annulus of adhesive forming a barrier to prevent migration of cells and increase mechanical coupling of the lens and lens capsule.

Some embodiments are related to methods of manufacturing a shell for an implantable polymeric cavity configured to receive a filling fluid or gas. The filling fluid may be curable after filling, or may remain in a liquid form. A valve can be used to access the internal contents of the polymeric cavity. In other embodiments, a tube is connected to the cavity for access. An expandable polymeric cavity may be formed in accordance herewith by coating a dissolvable mold, then dissolving and removing the mold to release the cavity. The mold may have an arbitrary shape and surface contour, including fine features, which are imparted to the polymeric cavity coated thereover.

Some embodiments are related to a process for fabricating a polymeric cavity to function as an implantable device. The process may involve coating the surface of a removable mold with one or more layers of one or more polymers and then removing the coated mold after the walls of the polymeric cavity mold have been formed. For example, the mold may be removed by first being dissolved, melted, or sublimed, following which the mold remnants pass through the walls of the polymeric cavity or are otherwise removed, e.g., by aspiration (via, for example, a valve or tube attached to the wall of the cavity).

A valve may be placed on and bonded to the surface of the polymeric cavity after the coating surface has been applied but before dissolving the dissolvable mold. The valve may, for example, be attached to the wall by coating the valve and polymeric cavity with parylene.

In some embodiments, a process for fabricating an implantable polymeric cavity with an attachment tube involves coating the surface of a dissolvable mold with a polymer, elastomer, or parylene, and following dissolution, removing the mold remnants through a tube molded into the cavity.

In some embodiments a cryogenic mold is coated with a polymer and then allowed to melt or sublimate (e.g., at elevated temperature). The melted or sublimated mold remnants are removed from the polymeric cavity by one or more of passing through the walls of the polymer, removal through a tube, or removal through a valve in the polymeric cavity. The mold may be, for example, a wax mold or a metal (such as a Field's metal) or polymer with a relatively low melting point.

In some embodiments, a manufacturing process in accordance herewith may utilize two mold cavities, each corresponding to a specific surface profile of the reservoir. An uncured elastomer may be applied to the mold cavities, and the cavities spun to distribute the elastomer along their surfaces. The mold cavities may be assembled to form an enclosed balloon of the uncured elastomer, which is cured inside the mold cavity to form a hollow balloon with a desired shape. A pre-manufactured valve may be fastened to the surface of the balloon if desired.

In some embodiments, a pre-manufactured valve is fitted within a recess on the mold so as to become integral with the balloon during curing thereof. The valve may, for example, have a thickness larger than, equal to or smaller than the depth of the recess in the mold cavity. The valve may be made of the same material as the elastomer, or it may be, partly or entirely, a different material. Excess elastomer may be removed after spinning, e.g., by mechanical scraping, laser cutting, chemical etching, etc. Alternatively, a pinch-off blade may be incorporated into one or both mold pieces to generate a clean-cut balloon edge.

In some embodiments, a layer of release reagent may be applied to the surface of the mold before spinning elastomer onto the mold cavities. The release reagent may be applied by spray coating, spin coating, vapor deposition, soaking, etc. At least part of the spinning may take place off-axis to redistribute the elastomer on the mold cavities, e.g., after the two mold pieces are assembled together and before the curing process. Curing may occur by means of thermal baking, UV exposure, and room temperature curing.

In some embodiments, the manufactured balloon may be filled with silicone oil liquid to form a reservoir for human implantation. For example, if a valve is present, a hollow needle may be used to access the interior of the balloon through the valve to permit injection of the silicone oil. Upon withdrawal of the needle, the aperture on the valve piece closes by the elastic deformation. The liquid-filled reservoir may be an intraocular lens, a breast implant, etc. Fluorosilicone or phenyl substituted silicone may be used as a composite material to prevent the diffusion of silicone oil through the balloon wall.

Some embodiments are related to a method of manufacturing an elastomeric reservoir for a medical implant. The method includes providing a pair of complementary platform structures each having a receiving surface, applying a high-viscosity uncured elastomer to each of the receiving surfaces, joining the platform structures to one another to form an cavity between the platform structures that is bounded by the receiving surfaces, and curing the elastomer inside the cavity to form an elastomeric reservoir.

The method can includes distributing the uncured elastomer uniformly over the receiving surfaces prior to the joining and the curing as well as removing excess elastomer from at least one of the receiving surfaces after the distributing and before the joining. The removing can include mechanical scraping, laser cutting, chemical etching, or removing of masking. At least one of the platform structures can include a pinch-off blade configured for removing a protruding rim of elastomer upon joining of the platform structures. The elastomeric reservoir can form an intraocular lens, a breast implant, a testicular implant, balloon-type scleral buckle, or a gastric sleeve. The method can include depositing a release reagent to the receiving surfaces before the applying, for example by spray coating, spin coating, vapor deposition, or soaking. The method can further include loading a pre-manufactured valve into a recess within one of the receiving surfaces. The pre-manufactured valve can comprise a pre-cured or partially cured elastomer of a same material as the applied elastomer. The pre-manufactured valve can have a thickness equal to or different from a depth of the recess. The method can further include loading a first portion of the valve into the recess prior to the applying and loading a second portion of the valve into the recess following the applying and prior to the curing. The method can include inserting a needle into the reservoir through the valve, filling the reservoir with silicone oil, removing residual gas within the reservoir, and removing the needle. The applying can include spinning, spraying, or evaporating. The method can further include coating one or more layers of elastomers that are different from the applied elastomer over the applied elastomer. The platform structures can include alignment features facilitating the joining, for example a convex slope on one of the platform structures and a concave slope on the other platform structure. The method can include fastening a pre-manufactured valve to a surface of the reservoir following the curing. The method can include spinning the platform structures to distribute the uncured elastomer following the joining. The spinning can include off-axis, on-axis, or multiple-axis spinning. The curing can include thermal baking, UV exposure, or room temperature curing. The method can further include applying a parylene layer to the elastomer following the curing of the elastomer. The method can further include subjecting the cured elastomer to plasma treatment. The method can include adding one or more layers of fluorosilicone to the elastomer prior to or following the applying. The high-viscosity uncured elastomer can have a viscosity over 6,000 centipose.

Some embodiments are related to an intraocular lens apparatus, including a biocompatible polymer balloon fillable with a medium, a medium to fill the biocompatible polymer balloon, the balloon configured for insertion into a capsular bag of an eye, and one or more chromophores or wavelength altering agents configured to attenuate certain wavelengths of light.

One or more chromophores or other wavelength altering agents can be incorporated into one or more membranes of the biocompatible polymer balloon. An anterior membrane of the balloon and a posterior membrane of the balloon can be included. Interaction between the anterior and posterior membranes can occur only at predetermined level of lens accommodation. A specific portion of the one or more membranes can have a chromophore or wavelength altering agent, while at least one portion does not have the chromophore or wavelength altering agent. Optionally, the specific portions of the one or more membranes are only in the visual field during predetermined levels of accommodation of the lens.

Specific portions of the one or more membranes may only be in a visual field during a predetermined level of pupil dilation. One or more chromophores or other wavelength altering agents may be incorporated into the medium to fill the biocompatible polymer balloon. A photochromic dye can be used as the wavelength altering agent. The photochromic dye can be configured to attenuate portions of the lens selectively in low light conditions. The biocompatible polymer balloon membranes can consist of one or more layers.

Some embodiments relate to a system of two accommodating lenses used in contralateral eyes, each lens with different chromophores or different concentrations of wavelength altering agents.

Some embodiments relate to an accommodating intraocular lens apparatus that includes an anterior membrane having a first annulus section of a chromophore or wavelength altering agent, and a posterior membrane circumferentially fused with the anterior membrane, the membranes forming a balloon fillable with a medium, the balloon configured for insertion into a capsular bag of an eye, the posterior membrane having a second annulus section of a chromophore or wavelength altering agent, wherein the first and second annulus sections are spaced so as to align during a predetermined level of accommodation of the balloon.

Some embodiments relate to an accommodating intraocular lens apparatus that includes a biocompatible polymer balloon Tillable with a medium, the balloon having an external layer not incorporating a chromophore or wavelength altering agent and an internal layer incorporating the chromophore or wavelength altering agent, the balloon configured for insertion into a capsular bag of an eye.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 is a cross section of a human eye in a non-accommodated (left side) and an accommodated state (right side).

FIG. 2 is a cross section of a human eye with a traditional capsulotomy of the prior art.

FIG. 3 is a cross section of a human eye with a minimally invasive peripheral capsulotomy in accordance with an embodiment.

FIG. 4 is a cross section of a human eye with an injectable accommodating intraocular lens being injected into the capsule in accordance with an embodiment.

FIG. 5 is a cross section of a human eye with an injectable accommodating intraocular lens being inflated with an optically clear medium inside the capsule in accordance with an embodiment.

FIG. 6 is a cross section of a human eye with a peripheral incision and an injectable accommodating intraocular lens inserted into the lens capsule in a non-accommodated (left side) and an accommodated state (right side) state in accordance with an embodiment.

FIG. 7 is an injectable accommodating intraocular lens in accordance with an embodiment.

FIG. 8 is the injectable accommodating intraocular lens with a flexible central portion in accordance with an embodiment.

FIG. 9 illustrates a wagon wheel-shaped frame port having needle-pierceable portions in accordance with an embodiment.

FIG. 10 is a chart illustrating experimentally determined thicknesses of a valves that self-seal the lens at different pressures.

FIG. 11 is a chart illustrating needle diameters found to fill injectable accommodating intraocular lenses in a specific amount of time.

FIG. 12 is a picture of a lens with an injection tube before dissolvable mold material has been removed in accordance with an embodiment.

FIG. 13 is a close-up picture of a 1.5 μm thick parylene lens with its injection system cauterized in accordance with an embodiment.

FIG. 14 is a picture of a lens with mold material dissolved and an injection system attached in accordance with an embodiment.

FIG. 15 is a picture of a parylene lens filled with 20 centistoke silicone fluid in accordance with an embodiment.

FIG. 16 is a picture of an exemplary composite parylene-on-silicone lens in accordance with an embodiment.

FIG. 17 illustrates an exemplary air bubble capture mechanism in accordance with an embodiment.

FIG. 18 illustrates a silicone intraocular lens manufacturing process using molds in accordance with an embodiment.

FIG. 19A is a picture of a 30 μm silicon elastomer shell fused on two halves around the equator and entry valve in accordance with an embodiment.

FIG. 19B is an elevated picture of the shell of FIG. 19A.

FIG. 20A is a picture of an intraocular lens implanted in a cadaver human eye in accordance with an embodiment.

FIG. 20B is a picture of the implanted intraocular lens of FIG. 20A with a section of the iris removed to show a lens patch (valve).

FIG. 21A is a side elevation view of an intraocular lens patch with a slit that is closed in accordance with an embodiment.

FIG. 21B is a side elevation view of the intraocular lens patch of FIG. 21A that is about to be pierced by a needle.

FIG. 21C is a side elevation view of the intraocular lens patch of FIG. 21B that is pierced by a needle.

FIG. 22A is a side elevation view of an intraocular lens patch with a stepped slit that is closed in accordance with an embodiment.

FIG. 22B is a side elevation view of the intraocular lens patch of FIG. 22A that is about to be pierced by a needle.

FIG. 22C is a side elevation view of the intraocular lens patch of FIG. 22B that is pierced by a needle.

FIG. 23 illustrates manufacturing an additionally reinforced section of a lens membrane in accordance with an embodiment.

FIG. 24 illustrates a representative procedure for manufacturing a silicone balloon in accordance with an embodiment.

FIG. 25 illustrates spinning alternatives in accordance with embodiments.

FIG. 26 illustrates forming a valve integrally with a balloon using a recess area in a mold in accordance with an embodiment.

FIG. 27 illustrates affixing a valve patch to a cured balloon in accordance with an embodiment.

FIG. 28 illustrates a two-piece valve configuration in accordance with an embodiment.

FIG. 29 illustrates an undesired edge around a freshly cured balloon in accordance with an embodiment.

FIG. 30 illustrates removing the edge of the cured balloon in accordance with an embodiment.

FIG. 31 illustrates another approach to removing the edge of the cured balloon in accordance with an embodiment.

FIG. 32 illustrates a pinch-off mold design in accordance with an embodiment.

FIG. 33 illustrates three different pinch-off blade mold configurations in accordance with embodiments.

FIG. 34 illustrates a misalignment of molds.

FIG. 35 illustrates an example of a convex slope on an anterior mold in accordance with an embodiment.

FIGS. 36A and 36B illustrate convex and concave contours in accordance with embodiments.

FIG. 37 illustrates another embodiment to align mold pieces in accordance with an embodiment.

FIG. 38 illustrates using a release reagent in accordance with an embodiment.

FIG. 39 illustrates a spin coating process in accordance with an embodiment.

FIGS. 40A and 40B illustrates an off-axis spin step in accordance with an embodiment.

FIG. 41 illustrates a mold being spun around two or three axes simultaneously in accordance with an embodiment.

FIGS. 42A through 42C illustrate a representative manufacturing procedure in accordance with an embodiment.

### DETAILED DESCRIPTION

An injectable accommodating intraocular lens system is disclosed as well as devices and systems relating thereto. In various embodiments, the lens is constructed to form a flexible, thin, biocompatible bag. During surgery, the bag is filled with an optically clear medium, such as silicone fluid. During insertion into the lens capsule of the eye, the intraocular lens has little or no medium in it in order to reduce its overall dimensions, allowing insertion through a small surgical incision (e.g., 0.25 mm) This may be performed by accessing the internal contents of the lens and evacuating the lens before implantation. After insertion, the intraocular lens is inflated with the clear medium to a target dioptric power. Once inserted, the accommodating intraocular lens deforms in response to the natural focusing mechanism of the existing ciliary muscle to change focus in a manner similar to a human lens.

Because of its ability to fit through small incisions, the injectable accommodating intraocular lens can be used with minimally invasive surgical techniques, making recovery time for a patient more rapid and reducing surgical complications. A minimally invasive surgical procedure, resulting in an ability of the intraocular lens to accommodate, makes this device well suited not only to fix cataracts, but also for other less serious conditions such as presbyopia.

### The Bag

The bag of the injectable accommodating intraocular lens is typically made of an optically clear flexible material. This allows it to be deformed by contraction and relaxing of ciliary muscles during accommodation. However, other biocompatible materials may also or alternatively be used. In some embodiments, the bag consists of a biocompatible polymer, for example, a parylene, acrylic, and/or silicone elastomer.

Silicone elastomers include but are not limited to one of or combinations of fluorosilicone, silicone, and phenyl substituted silicone where phenyl groups are substituted along the silicone backbone to increase the refractive index and diffusion of materials, such as silicone oil, through the elastomer.

Fluorosilicone and phenyl substituted silicones both prevent swelling of the silicone bag if a silicone oil is used as the filling fluid. This acts to maintain the shape of the bag after filling. In addition, fluorosilicone and phenyl substituted silicones reduce the ability of silicone oil to diffuse through the wall of the bag. They also allow air to diffuse through the walls, thereby allowing air bubbles to diffuse and escape through the walls of the lens while trapping the optically clear filling fluid inside the lens, such as silicone oil that can swell the balloon. Furthermore, phenyl substituted silicone can increase the refractive index of the bag.

In some embodiments, the bag comprises a composite of more than one material layered on top of another, for example, parylene coating a silicone elastomer. A composite structure can be used to alter the flexing properties of the lens, improve stability of the materials, prevent lens epithelial cells from traveling across the intraocular lens, and modify the refractive index of the lens.

In some embodiments, parylene can be deposited into the pores of the silicone elastomer, thereby reducing the permeability of the silicone elastomer to the filling fluid. For example, nanopores in the silicone may be closed via deposition of parylene into the pores. If a thin enough parylene coating is deposited, or only deposited in the nanopores, the flexibility of the lens can be retained. A thicker deposition of parylene can be used to modify the flexibility of the lens. This thicker parylene can be deposited in certain areas of the lens to preferentially allow certain areas of the lens to be stiff while others maintained their flexibility. This preferential method of deposition allows the lens to have increased amplitudes of accommodation by optimizing changes in lens shape. Because parylene has a high index of refraction, deposition of parylene can be used to alter the refractive index of the composite shell.

Parylene and silicone bags in accordance herewith may be under 100 micrometers (μm) in thickness, and in some embodiments under 10 μm. Parylene bags under 10 μm in thickness along the optical axis have been found to be effective, and silicone bags under 40 μm along the optical axis have been found to be effective. In some configurations, there may be a slightly thicker portion along the equator. Thickness along certain areas may be as much as 200 μm; however, the thicknesses are preferably 50 μm or less.

For compatibility with subsequent ocular procedures, the bag and optically clear medium are constructed of materials that are not damaged by a Nd:YAG laser, sometimes referred to as a YAG laser. Furthermore, the materials used along the visual axis of the device, such as parylene, desirably are stable—despite light exposure for decades—and do not change color over time.

In one embodiment of the invention, the bag has a series of thicker sections meant for a YAG or femtosecond laser beam to pass through without damaging the lens. The posterior half of the lens can be manufactured thicker than the anterior half of the lens to prevent rupture of the lens due to the YAG/femtosecond laser. In addition, the posterior half of the lens can be made with a series of discontinuous thicker sections where the YAG/femtosecond laser is meant to be applied to the poster capsule. These thicker sections are resistant to the intensity of the YAG/femtosecond laser and, therefore, prevent rupture of the lens.

One exemplary profile for the thicker sections include a horseshoe configuration, wherein the YAG/femtosecond laser is applied along the horseshoe shape of the thicker area. Nominally the open end of the horseshoe is made to face inferior relative to the patient during implantation so as to allow the flap created in the posterior lens capsule to unfold and open with gravity. The horseshoe configuration maintains lens flexibility on the posterior side because the discontinuity still maintains flexibility of the lens. Another exemplary profile is a cross passing through the center of the lens where the YAG/femtosecond laser is applied.

Another exemplary profile is a series of discontinuous thicker areas that prevent rupture of the lens wall when YAG/femtosecond laser is applied to them and not the surrounding areas. These thicker areas of the lens allow lens flexibility because the surrounding areas are maintained thin and are therefore still flexible. Exemplary placements of the discontinuous areas include a horseshoe pattern as described previously and/or a cross pattern through the center of the lens.

For these thick areas, there may be fiduciary marks to indicate where they are located in order to allow an ophthalmologist to locate the thick areas and target the YAG/femtosecond laser. This can be important if the surrounding areas of the lens are not resistant to YAG/femtosecond laser such that missing the YAG/femtosecond points may cause damage and/or rupture to the lens wall.

When inserted and inflated, the bag can be mechanically coupled to the lens capsule in order to accommodate when the ciliary muscles contract. The coupling can occur at the periphery of the lens or along any point where the bag and capsule come in contact with one another. This allows the device to function after both anterior and posterior capsulotomies have been performed.

In operation within the eye, ciliary muscles contract and relax, causing the capsule diameter to decrease and increase. In a manner similar to the intact human crystalline lens, the lens capsule then transmits this force to the prosthetic accommodative intraocular lens. As the diameter of the capsule decreases, the anterior and posterior surfaces of the lens round, decreasing their radius of curvature, and in turn increasing the power of the lens.

To prevent anterior or posterior capsular opacification, a circumferential square-edge protrusion is made around the periphery of the lens at the posterior and/or anterior side in order to prevent migration of lens epithelial cells along the surface of the capsule. In some implementations, a protrusion is made around the periphery of the lens at the anterior side. The anterior ridge is particularly important for surgical cases when only a small capsulotomy is performed because lens epithelial cells may migrate to the anterior surface of the capsule causing visual disturbances. These square edges contact the lens capsule, inducing strain and a continuous circumferential angular discontinuity, which forms a barrier preventing lens epithelial cells from migrating from the periphery to the optical axis.

In one implementation, the bag is made from a material with a higher index of refraction than the optically clear medium. The two materials form a single lens with a variable index of refraction, similar to a gradient index (GRIN) lens. Two exemplary materials for this implementation are parylene with a refractive index of 1.6 and silicone fluid with an index of 1.4. Likewise phenyl substituted silicone can be used for the bag and a silicone oil for the fill material. Different indexes of refraction for the bag and optically clear medium form a single lens with a variable index of refraction.

In one implementation, a shape memory alloy, such as nickel titanium (Nitinol), is used to non-invasively adjust the power of the lens. The shape memory alloy is integrated into the lens. When the shape memory alloy changes shape, it causes the lens deform, therefore changing dioptric power. The shape memory alloy is actuated with a remote source, such as a radio frequency (RF) transmitter. Therefore, no surgically invasive procedure is required to modify the power of the lens after implantation.

### Air Bubble Capture

One implementation of an intraocular lens device has a feature that facilitates capture of air bubbles. This feature is typically located along the periphery of the lens. One example of this is a narrow inlet that expands into a larger out-pocket. Once an air bubble travels through the inlet, it is caught in the larger out-pocket. Exemplary profiles of the out-pocket include a simple chamber or a maze. Furthermore, certain implementations of the lens have a one-way valve, for example a flap valve, which allows the air bubble into an out-pocket but prevents it from escaping. Any residual air bubbles that have not been removed are then positioned and captured.

One implementation of an intraocular lens device contains a section of the lens that naturally allows an air bubble to diffuse through. This section may be located along the superior aspect of the lens or along the periphery of an air-bubble capture feature. In certain embodiments of the invention, the walls of the lens allow air bubbles to diffuse through the lens preferentially. For example, a silicone elastomer, such as a phenyl substituted silicone, will not allow significant silicone oil to escape the lens while allowing air bubbles trapped in the lens to diffuse through the walls.

One implementation of an intraocular lens device contains a section of the lens that interacts with an instrument to allow surgical removal of the air bubble. The instrument either pierces the periphery of the lens to remove the air bubble or causes the air bubble to diffuse through the lens wall. The air bubble may diffuse across the wall of the lens if vacuum is locally applied externally. It is generally preferable to remove air bubbles during the surgical implant procedure.

### Optically Clear Medium

The intraocular lens bag can be filled with an optically clear medium with an index of refraction higher than the surrounding aqueous humor and vitreous. A low viscosity silicone fluid or hydrogel may be used, for example. A low viscosity silicone fluid not only allows the lens to respond quickly to changes in the ciliary muscle, but also allows rapid injection through small diameter hypodermic needles. The use of a hydrogel or equivalent material allows tuning of the bulk modulus of the lens for optimal accommodative amplitude. Although hydrogel is used as an exemplary material, equivalent materials can be used. Likewise, a solute/solvent can be tuned by the amount of solute. An example of this is sugar water. More sugar can mean a higher index of refraction of the filling liquid. Nanoparticles can also be used for this (as described below for nanocomposites).

In one intraocular lens implementation, the optically clear medium is used to change the refractive power of the lens. This is accomplished by changing the ratio of fluids in the lens. It can also be accomplished by using a medium having a tunable refractive index. In the former case, as the lens is filled it changes shape, and therefore optical power. In the latter case, the lens power is modified by adding or exchanging fluid with a different refractive index or changing the refractive index of the medium itself. As an example, changing the concentration of a dissolved solute or percentage of nanocomposite in the medium can change the refractive index of the fluid and hence the dioptric power of the lens. This approach can be used to adjust optical power during the initial procedure as well as after surgery, for example to adjust for visual changes.

If desired, a blue blocking capability may be added to the lens. For example, a colored biocompatible polymer that absorbs harmful blue or small wavelengths of light can be added. The balloon can attenuate ultraviolet A or B rays. In addition, blue blocking and ultraviolet A and/or B blocking capability can be added to the fluid filling the lens.

In certain embodiments, the chromophore may be used for other wavelengths. This includes areas of the visible spectrum as well as portions of the invisible spectrum. These embodiments may aid in treatment of light sensitivity experienced by certain patients. In other embodiments, the chromophore is used to increase contrast sensitivity during day and night vision. Likewise, the lens can be polarized for enhanced vision.

In some embodiments, a photochromic substance is used to increase contrast and visual acuity during the day or at night. If multifocality is used on the lens surface, a photochromic additive may be added to certain compartments of the lens that blocks certain regions of the lens corresponding to certain focal points of the lens. As an example, during night time, the near focal points may be blocked, preventing halo or glare from the near focal point.

To understand how chromophores can be used to enhance vision, it may be important to understand the physiology of color vision. The human eye perceives color through cone cells. Three different cone cells are present in the eye: short (S), medium (M), and long (L) cone cells. Each of these cells has a spectral response to different wavelengths, and at certain wavelengths the spectral response overlaps between the cells. As an example, L cones have a range between 500-700 nm with a peak at 564-580 nm. M cones have a range between 450-630 nm with a peak between 534-555 nm. Color vision is detected by the different amount of response between the S, M, and L cells. Therefore, although one wavelength may cause a response in both L and M cells, it will typically cause a higher stimulation of one type of cell. This leads to the correct color being seen.

There is normally a spectral response over a continuum of wavelengths when viewing an object. Therefore, if two objects are viewed, the colors may look somewhat similar due to the differential response of the (S, M, L) cone cells. However, to differentiate the objects from one another, a certain portion of the spectrum may be blocked to increase the differential S, M, and L response. This blocked portion may be considered noise when differentiation between the two objects is considered. By removing the noise, the signal to noise ratio is increased.

As a very simple example, consider viewing a 451 nm wavelength object on a 450 nm wavelength background. If 450 nm were blocked, the object would be easily visible, appearing as a 451 nm object on a black background. Without blocking, the two objects might be difficult to differentiate due to the similarity of the colors. Likewise, certain wavelengths can be attenuated to increase signal to noise when trying to differentiate between two objects.

Clinically in the case of macular degeneration, patients often have reduced contrast vision or poor color vision. Therefore, yellow, orange, and brown tinted lenses can make it easier to identify certain items such as steps and curbs. Likewise, yellow and orange tinted lenses can increase contrast. Therefore, chromophores in the lens can be used to enhance contrast and visual performance.

For colorblind patients a chromophore may be used to block certain wavelengths. This can be used to increase contrast sensitivity relative to certain wavelengths, aiding in distinguishing between different colors of light. For example, by blocking certain frequencies in the yellow-to-green range it is possible to improve color distinction in red-green colorblind patients. Depending on the amount of total attenuation of light, it may cause a deficit in other portions of the visual field, such as in the yellow/green spectrum.

In some embodiments, different chromophores are used for two lenses to increase image contrast. When one lens is implanted in one eye and another is implanted in the contralateral eye, overall image contrast is enhanced. In the case of colorblind patients, providing a differential spectral response between the two eyes can provide a difference in certain colors, e.g. making a green differentiable from a red. While the red is blocked, the green is free to propagate. Therefore, the red appears as dark in one eye and not in the other. The green appears the same intensity in both eyes. This prevents color loss due to a total blocking of one color.

Chromophores may be added to certain portions of the lens, such as the central viewing axis, half of the lens, or in a concentric ring to allow it to be active only upon pupil dilation. Multiple sections (e.g., anterior membrane, posterior membrane, filling fluid, additional membranes and fluids in various sections of a multi-chambered intraocular lens) can incorporate chromophores to create an additive wavelength blocking result. To prevent complications of structure deficiency or non-biocompatibility, some chromophores can be retained in an internal medium and/or internal layer of the lens membrane. In some embodiments, chromophore combinations provide varying outcomes according to accommodation. This is done by creating specific regions (e.g., on the anterior membrane) that only interact with another region (e.g., a portion on the posterior membrane) during specific accommodation or pupil dilation.

In some embodiments, a photochromic substance is used to increase contrast and visual acuity during the day or at night. If multifocality is used on the lens surface, a photochromic additive may be added to certain compartments of the lens that blocks certain regions of the lens corresponding to certain focal points of the lens. As an example, during night time, the near focal points may be blocked, preventing halo or glare from the near focal point.

A photochromic substance may be used to darken a portion of the lens relative to (high or low) light intensity, thereby mimicking a natural pupil. This can extend the depth of field of the eye, although there is a loss of a certain amount of light.

In other embodiments the photochromic substance causes a blue blocking or ultraviolet blocking condition when exposed to either visible light or ultraviolet light. Therefore, when exposed to high intensity light, the photochromic substance blocks high-energy visible light. This may occur through the whole lens or only certain regions of the lens (e.g., only the central optical axis of the lens).

Examples of photochromic substances include triarylmethanes, stilbenes, azastilbenes, nitrones, fulgides, spiropyrans, napthopyrans, spiro-oxazines, quinones, diarylethenes, azobenzenes, and inorganic photochromics. For example the following molecules may be used as a photochromic dye or as a derivative of a photochromic dye: 1,3-Dihydro-1,3,3-trimethylspiro[2H-indole-2,3′-[3H]naphth[2,1-b][1,4]oxazine]; 1′,3′-Dihydro-1′,3′,3′-trimethyl-6-nitrospiro[2H-1-benzopyran-2,2′-(2H)-indole]; and 1′,3′-Dihydro-8-methoxy-1′,3′,3′-trimethyl-6-nitrospiro[2H-1-benzopyran-2,2′-(2H)-indole]. This is not meant to be limiting and these can be purchased from manufacturers such as Vivimed Labs of India and Sigma-Aldrich of St. Louis, Mo., U.S.A.

Spiropyrans and spirooxazines can be used with a stabilizer to provide a barrier to chemicals and/or oxygen. In certain embodiments the barrier is the external lens wall and the photochromic substance is in the fluid. In other renditions the fluid itself acts to prevent undesirable compounds from entering and interfering with the photochromic agent. Stabilizers may include compounds that absorb ultraviolet light, or an anti-oxidant agent.

Photochromic agents can be added in small amounts to create an effective amount of color change. In certain embodiments, the amount of photochromic agent is less than 1% by weight. Photochromic agents may be added directly to the filling fluid, such as by adding to a silicone oil. In addition, they can be functionalized for increased solubility in the filling fluid. In other renditions, the photochromic agent is cross-linked with functional groups in the filling oil or lens membrane (e.g. cross links in a chemically functionalized side chain of the poly dimethyl siloxane backbone). In other embodiments, the photochromic agent is mixed in using a solvent (e.g. organic solvent such as toluene, xylene, and tetrahydrofuran (THF)) to first dissolve the photochromic agent, and then mixed with the filling fluid. The first solvent may be removed from the remaining filling fluid and photochromic agent (e.g. separation, evaporation, distillation, boiling).

When large molecules are used for the agent, or when a photochromic agent is added to a large side chain molecule, it is not able to pass through the walls of the lens. Therefore, the agent is effectively trapped inside the lens, preventing migration from the lens to the surrounding aqueous.

Photochromic compounds may be used to increase image contrast in certain viewing conditions by inducing a tint to the lens, e.g. in lighted conditions. In dark conditions the color may be removed, thereby allowing more light collection in low light conditions.

In some embodiments, the chromophore or photochromic agent is placed on or incorporated into either the anterior or posterior membrane of the lens. In some embodiments, it is added to the filling medium.

In some embodiments, more than one chromophore type or wavelength altering agent may be used inside the lens. For example, one may be used on the anterior surface, another is used on the posterior surface, and a third is used in the filling medium.

In some embodiments, the interaction during accommodation causes the chromophores or wavelength altering agents on the anterior portion of the lens to interact with the chromophores or wavelength altering agents on the posterior portion of the lens. This may be a function of accommodation or a focusing level of the lens. As an example, a series of concentric rings on the anterior portion may focus on a specific portion of the posterior lens. This specific portion of the posterior lens changes depending on curvature of the anterior lens. Therefore, during one focal length it will focus on a corresponding ring on the posterior portion of the lens. At another focal length it passes through a portion of the lens that has either no chromophore, differing chromophore, or different chromophore concentration. Likewise, the rings may have differing concentrations of the same chromophore.

High concentrations of chromophores or wavelength-attenuating dyes can cause undesirable effects to the mechanical and chemical structure of materials. Therefore, it may be desirable to use a low concentration of chromophores or wavelength altering agent. In the case of adding chromophores to a lens, a desired outcome can be obtained while a low chromophore concentration is maintained so as to not compromise the mechanical integrity by increasing the lens thickness or total volume of chromophore lens. Alternatively, the lens may be in one or more layers. For example, an outer layer of the lens may contain no chromophores, therefore maintaining the structural integrity and biocompatibility of the lens.

Alternatively, to obtain the same outcome, the filling medium can include high concentrations of chromophores, but only use low concentrations of chromophores in the lens. This combination reduces the risk of compromising the mechanical and chemical structure of the lens material which is important in long-term implants. An additional buffer layer may be introduced as an internal coating to the lens to further prevent chemical effects of the high concentration chromophore filling medium on the lens. These embodiments benefit by negating the need to make the lens thick, which reduces lens elasticity and subsequently increases the incision size necessary for implantation. This option can be unique to liquid filled intraocular lenses, and it offers an advantage for this technology, whereas liquid filled intraocular lenses do not suffer from mechanical and chemical property damage due to adding these chromophores. In addition, the lens shell and the fluid can keep the chromophore insulated from oxidative damage and degradation over time.

In addition, pharmaceuticals can be added to the optically clear medium for intraocular delivery over an extended period of time. Refilling can occur through the injection site.

### Injection Site

The optically clear medium can be injected into the intraocular lens through an injection site. After optically clear medium has been injected into the lens, the injection site seals to prevent fluid leakage. For a single sealing design, sealing can be accomplished by injecting through a thin hollow tube attached to the lens. After injection, the tube is welded closed with local heat for cautery using a hot microtweezers or an equivalent micro device for safe intraocular use. Any peripheral residue of the tube is then removed from the surgical site. For multiple uses or fine adjustment of the lens, a reusable fill/discharge port can be made on the side of the lens bag. A hypodermic needle can pass through the port and inflate or deflate the lens accordingly.

One implementation of the injection site on the intraocular lens has a reusable fill-discharge port that is surgically accessible during insertion and adjustment, but it is moved peripherally off the optical axis once filling is complete to prevent visual disturbances. The injection site can be moved peripherally off the central 4.25 mm diameter of the lens. Preferably, the injection site is moved peripherally outside the center 6 mm diameter of the lens.

To avoid any potential damage to surrounding tissue from heat, alternate implementations of the injection site can use a self-sealing elastomer. During injection of the optically clear medium, a hollow tube, such as a small hypodermic needle, is used to pierce a slot in the elastomer membrane. During this process, the elastomer deforms away from the hypodermic needle. Next, the hollow tube slides through the incision. After injection of the fluid, the tube is removed and the elastomer retracts to its original position, sealing the incision. The thickness of the elastomer is determined by the amount of pressure in the lens and the injection diameter. The membrane can be equal to or greater than 25 μm and less than or equal to 2000 μm. In some embodiments, the membrane can be equal to or greater than 100 μm and less than or equal to 700 μm. In some embodiments, a range of between 160 μm and 350 μm is optimal. In other embodiments, a range of between 150 μm and 250 μm is optimal.

Optimally, the thickness should be thin enough to avoid contact with the surrounding tissue such as the iris, zonules, or ciliary muscle. In particular, it should be thin enough to avoid contact with the posterior iris. Clinically contact with this can cause a series of medical conditions including glaucoma or uveitis-glaucoma-hyphema (UGH) syndrome.

To prevent lateral movement of the injection tube during insertion, the elastomer injection site may be coated on one or both sides with a stiffer material, such as parylene. The stiffer material serves as a rigid guide for the injection tube, while the elastomer is used to seal the incision once the injection tube is removed. In one implementation, a guide for the injection needle is used to allow the needle to penetrate the same injection site multiple times. Multiple injections might be used for adjusting the base power of the lens after it has been placed in the same or subsequent surgical procedures.

One implementation of the injectable intraocular lens utilizes two injection sites. One injection site is used to infuse the optically clear medium, and the other site is used to aspirate the medium. Recirculation of the optically clear medium can be employed to remove unwanted debris or small air bubbles. It can also be used when exchanging a fluid of one index of refraction with another fluid of different index of refraction.

### Surgical Procedure

A compact cross section of the inflatable intraocular lens allows less invasive procedures than traditional surgical methods. One method of performing the a lens extraction can involve using a femtosecond laser to create a main incision, lens sectioning, and a small capsulotomy of 0.25 mm to 4 mm in diameter, preferably 1 to 2 mm in diameter. The crystalline lens is aspirated or emulsified out of the opening and the intraocular lens is then injected. The capsule is maintained intact to provide a good mechanical coupling between the capsule and the lens.

After insertion of the intraocular lens, it is filled with an optically clear medium. The dioptric power of the lens may be varied by adjusting the index of refraction of the medium, the amount of medium injected into the lens, a combination of these two parameters, or otherwise. Individually fillable compartments in the lens can separately store fluids with different indexes of refraction. The volume of fluid in each of the compartments can determine the combined dioptric power. The dioptric power of the lens can be determined before surgery, or monitored and adjusted during the surgical procedure. Furthermore, dioptric power can be adjusted post-surgery after the surgical incisions have healed or monitored on a temporal basis and adjusted. In one implementation, post-surgical adjustment of power involves entering the eye with a small-diameter hypodermic needle, cannula, or similar device, and then inserting an injection system into the injection site. In one implementation, a 30-gauge cannula or smaller is used to enter the eye, the injection system is inserted through the cannula, and then inserted into the injection site. In other implementations, a remote source, such as a radio-frequency source, is used to adjust the profile of a shape memory alloy embedded in the lens to change the dioptric power of the lens.

### Markings on Lens

In certain configurations, an intraocular lens has a series of markings on its anterior or posterior surface. The markings can be circular in shape. Deformation of the markings can indicate a shape change of a particular portion of the lens. Clinically this can be used to measure the amount of dioptric power in the lens. After implantation of the device, a clinician can visually observes the change in the marking to monitor the level of accommodation of the lens. In addition, the markings can be used to measure base power of the lens.

In certain renditions of the lens, the markings are used to monitor intraocular pressure in a non-contact manner. Clinically this can be used for monitoring glaucoma patients.

### Fixing the Lens to the Lens Capsule

In certain embodiments of the invention, a portion of the lens can be glued or otherwise adhered to the lens capsule. In an exemplary embodiment, the anterior portion of the lens is glued to the periphery of the anterior capsulorhexis. When glued to the lens capsule, the lens forms a rigid connection with the capsule, allowing it to deform in a physiologically similar manner to the original lens. This mechanical coupling can be used to increase the focusing ability of the lens, or to use a larger range of capsulotomy sizes and shapes. In addition, the adhesive prevents cells, such as lens epithelial cells, from migrating across the capsulorhexis. With an anterior capsulorhexis, the lens cells are prevented from creating opacification or visual disturbances to the anterior surface of the lens.

Adhesives can include temperature-responsive polymers, such as poly (N-isopropylacrylamide). The adhesive can be applied manually after the lens is placed or be previously mounted on the lens. In one embodiment of the invention, the adhesive is mounted on the lens in a circular annulus on the posterior and anterior surface of the lens. Upon injection and inflation of the lens, the adhesive sets, forming a seal along the optical axis of the eye. The seal can be 4.5 mm in diameter. Any residual cells in the equatorial region of the lens capsule can be prevented from migrating across the glued areas, thereby preventing opacification of the intraocular lens or the lens capsule.

### FIGURES

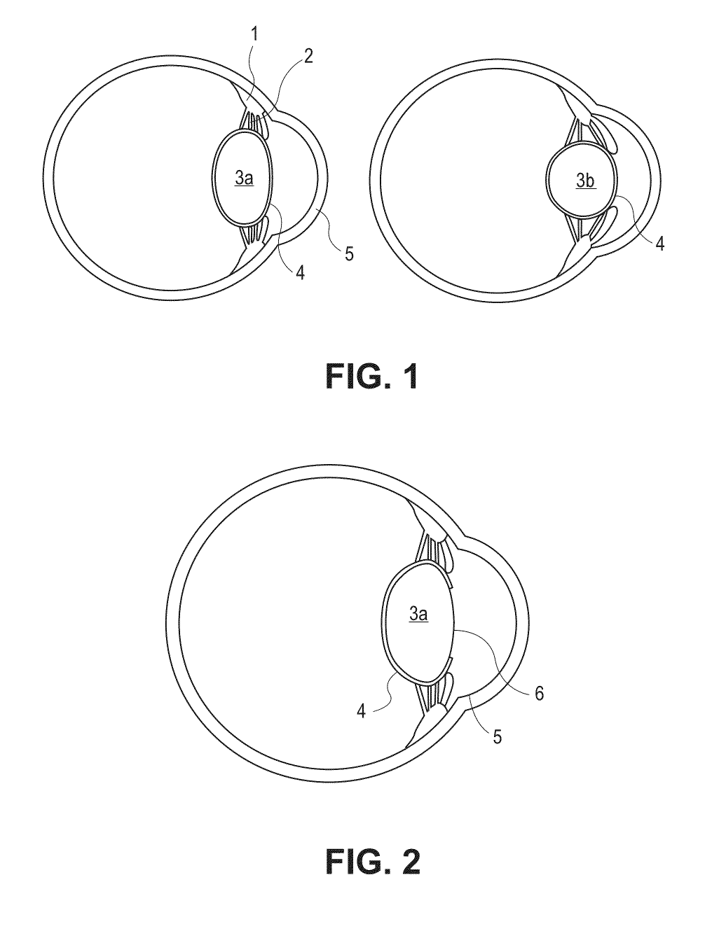

FIG. 1 is a cross section of a human eye in a non-accommodated (left side) and an accommodated state (right side). The normal physiology of the eye allows accommodation of crystalline non-accommodated lens 3a by contraction of ciliary muscle 1, which releases tension on zonules 2 and causes a rounding of the lens to accommodated lens 3b. The lens is surrounded by capsule 4, which transmits the force from the zonules to the lens itself.

FIG. 2 is a cross section of a human eye with a traditional capsulotomy. The surgical procedure of removing crystalline lens 3a and inserting an intraocular lens typically begins with cutting a main incision on the periphery of cornea 5. Next, a circular hole, known as a “capsulotomy” is cut with a diameter of approximately 5.5 mm in the anterior, central portion of lens capsule 6. This hole provides surgical access to lens 3a, which is then removed.

Unfortunately, the capsulotomy typically damages the integrity of lens capsule 4 and hinders its ability to fully transmit forces to the implanted lens. Integrity of the lens capsule is especially important for an accommodating intraocular lens, which often requires a strong mechanical coupling between the intraocular lens and the lens capsule.

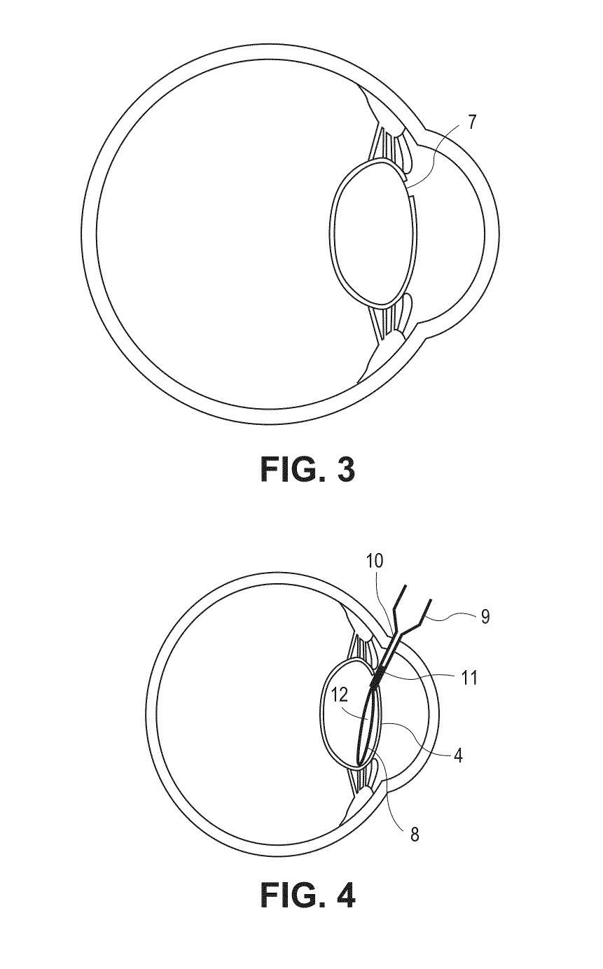

FIG. 3 is a cross section of a human eye with a minimally invasive peripheral capsulotomy in accordance with an embodiment. A small peripheral capsulotomy of less than 3 mm or 4 mm in diameter is made in the lens capsule, and the crystalline lens is extracted from the small incision. In one embodiment, peripheral incision 7 is less than 2 mm in diameter.

FIG. 4 shows an injectable, accommodating intraocular lens 8 being inserted into the lens capsule through a small peripheral incision, after the crystalline lens 3a has been surgically removed. The distal end of the insertion device 9 is first inserted through the main surgical incision 10 and then inside the lens capsule 4 through a small peripheral incision. Insertion device 9 has a narrow tube on its distal end. The narrow tube has an outer diameter smaller than the diameter of the peripheral incision, for example, less than 2 mm. In a preferred embodiment, the narrow tube has an outer diameter of 1 mm or less. The inner diameter of the insertion device is large enough to allow uninflated lens 8 to pass through without damaging the lens. During injection, the interior portion 12 of the injectable accommodating intraocular lens has little or no fluid in it so it can pass through insertion device 9.

Although FIG. 4 shows the lens inserted through a peripheral incision 7, it can be used with other incisions such as the traditional capsulotomy 6 shown in FIG. 2.

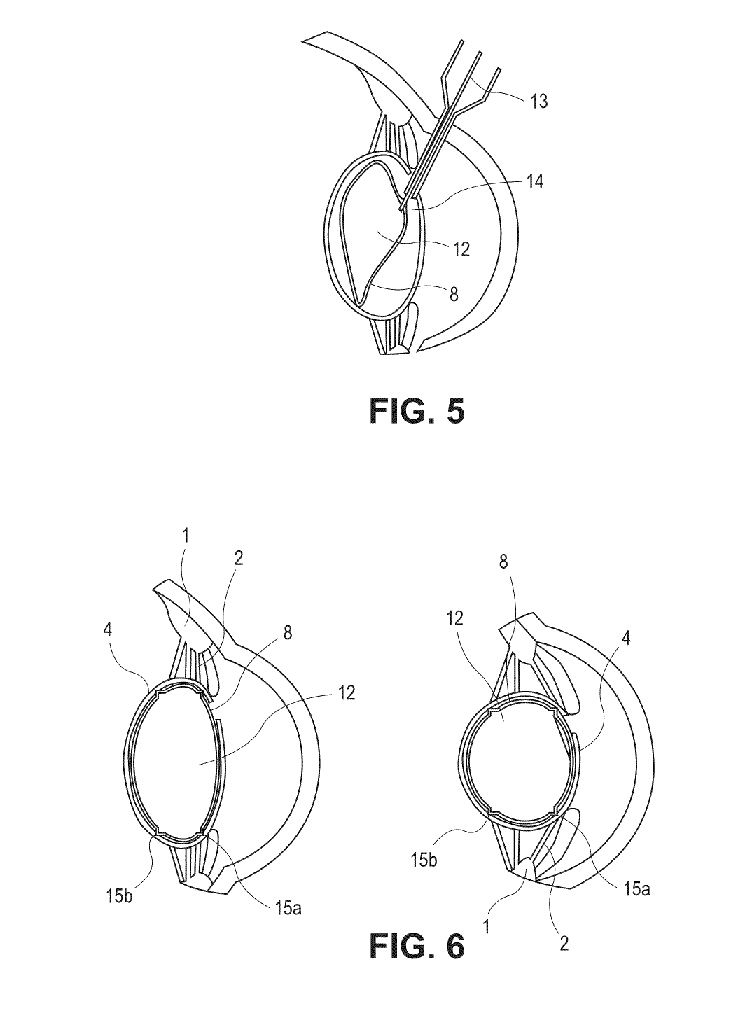

FIG. 5 shows injectable accommodating intraocular lens 8 being inflated with an optically clear medium. The medium passes from an infusion source on the proximal end of the fluid injector 13 through the fluid injector, into interior portion 12 of intraocular lens 8. The fluid injector passes into lens 8 through injection site 14, which is sealed after fluid injector 13 is removed. The method of sealing can be from the relaxation of an elastomer membrane such as silicone. In some embodiments, the elastomer of the injection site is stress relieved from the surround lens capsule and the adjacent or surrounding silicone elastomer. In some embodiments, external sealing, such as gluing or cautery, or otherwise, is employed.

In one embodiment the optically clear medium is a low viscosity silicone fluid, for example, 100 centistokes, and fluid injector 13 is attached to lens 8 before insertion of the lens. In some embodiments, 1000- or 5000-centistoke fluid is used. In this implementation, the lens 8 is inserted, and then immediately filled with the same tool.

FIG. 6 is a cross section of a human eye with a peripheral incision and an injectable accommodating intraocular lens inserted into the lens capsule in a non-accommodated (left side) and an accommodated state (right side) state. Lens 8 is filled to a base dioptric power with the optically clear medium in central portion 12. On the left side of the figure, the injectable accommodating intraocular lens 8 is in the unaccommodated, or non-accommodated state. On the right hand side of the figure the lens is in the accommodated state. Similar to the physiology of a healthy human lens, ciliary muscle 1 contracts, releasing tension on zonules 2 causing deformation of lens capsule 4 and lens 8 to round and change dioptric power. Lens 8 is in direct contact with the capsule 4, and this mechanical connection is typically required for lens 8 to change shape with the capsule.

The edge of the lens 8 fits tightly against lens capsule 4, providing a seal that prevents lens epithelial cells from migrating and causing posterior or anterior capsular opacification.

An implementation uses circular anterior lens protrusions 15a along the anterior portion of the lens and circular posterior lens protrusions 15b along the posterior portion of the lens to form circular ridges. The ridges cause an angular discontinuity in the lens capsule 4. This provides a barrier on the anterior and posterior surface of the capsule and lens, preventing equatorial lens epithelial cells from migrating to the center of lens capsule 4 or intraocular lens 8. In the exemplary embodiment, the ridges are set at a diameter larger than 4.25 mm stay out of the optical path of the lens/eye. This can prevent light scattering in the eye and subsequent visual disturbances.

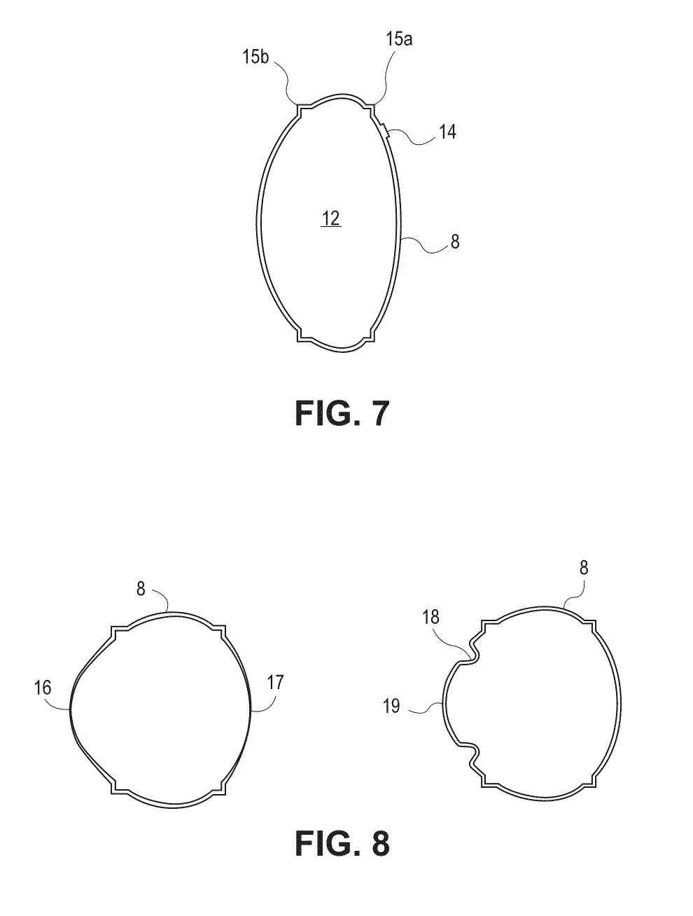

FIG. 7 is an injectable accommodating intraocular lens in accordance with an embodiment. Lens 8 is shown with central portion 12 filled with an optically clear medium. Injection valve 14 is shown in the periphery of the lens to prevent light scattering from the central portion of the lens. However, its placement is far enough from the periphery to allow surgical access through the dilated pupil. In one implementation, the injection valve is filled while it is surgically accessible and then moved peripherally away from the optical axis of the eye. Upon subsequent procedures for injection or removal of fluid, the valve is surgically moved towards the optical axis, fluid is injected or removed, and the valve is moved peripherally again. Anterior and posterior protrusions 15a and 15b are shown as well.

Similar to the human lens, this lens has multiple indices of refraction, similar to a gradient index (GRIN) lens. More specifically, the polymer shell of lens 8 may have a higher or lower index of refraction than the optically clear fluid inside.

FIG. 8 shows one embodiment of lens 8 with a central portion of the optic that is more flexible than the peripheral portions of the lens. In this figure, the central portion of the lens is thinned on the anterior side of the lens 16 and the posterior side of the lens 17 to increase flexibility. When the lens flexes during accommodation, the posterior central portion 16 and anterior central portion 17 of the lens flex more than other portions of the lens, amplifying the total curvature change and dioptric power change in the center of the lens. The central flexible portions 16 and 17 of the lens are less than 5 mm in diameter, and preferably about 3 mm in diameter.

Although the left side of FIG. 8 shows the central flexible portions of the lens as a thinned portion of the lens, one skilled in the art will recognize there are many methods to make the central portion more flexible. These include but are not limited to using two materials for the lens with the more flexible material used for the central portion of the lens. Alternatively, as shown on the right side of FIG. 8, hinged portion 18 of the lens can be used to cause central portion 19 between the hinges of the lens to preferentially flex. The hinged portion 18 can be located outside the visual axis of the lens to prevent visual disturbances, and preferably has a diameter of 4.25 mm or larger.

Although the illustrative embodiments of the invention shown in FIG. 8 are flexible on one side, one skilled in the art will recognize that any of the designs can be modified so the flexible portion of the lens is solely on the anterior, solely on the posterior, or on both sides of the lens.

One implementation of the injectable accommodating intraocular lens has multiple compartments that are individually filled. By differentially filling the compartments, the curvature of the lens can correct for aberrations in the optical system of the eye such as astigmatism.

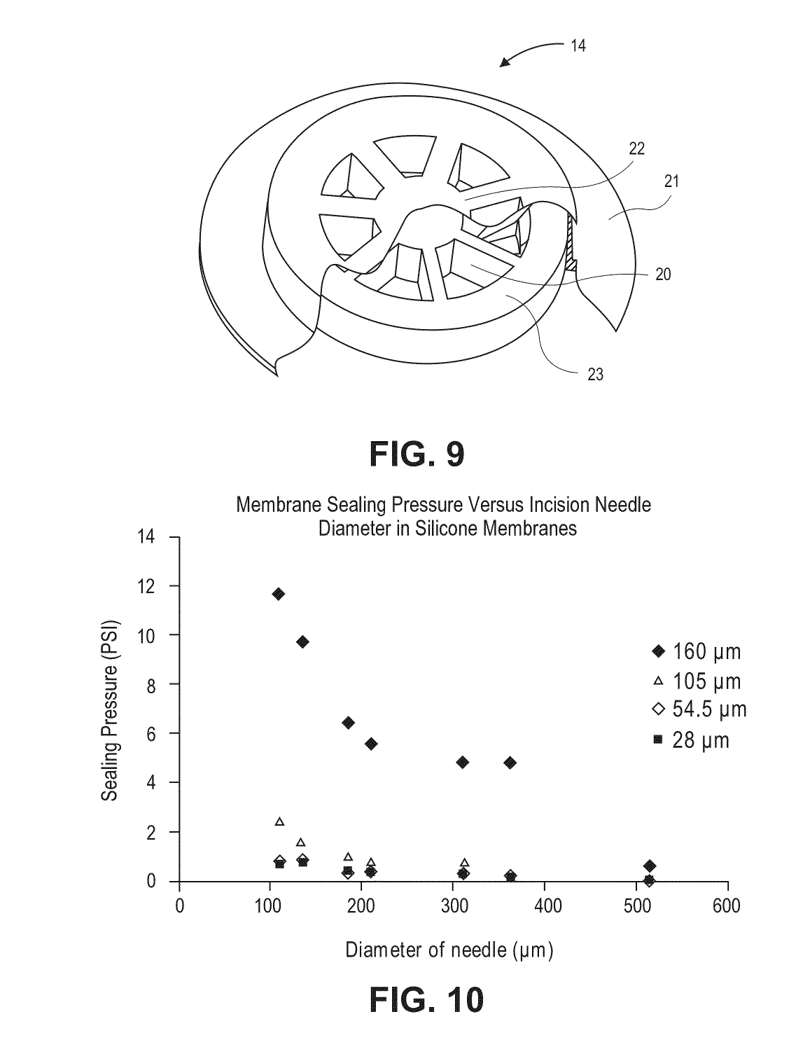

FIG. 9 shows an embodiment of injection valve 14 that utilizes a wagon wheel-shaped frame of stretchable elastomer 20 (e.g., silicone) or gel surrounded by supporting polymer 21 (e.g., parylene, fluorosilicone, or phenyl substituted silicone). This can be useful where two materials such as silicone and parylene do not adhere well to one another. Valve 14 has central portion 22 and peripheral portion 23. Supporting polymer 21 surrounds and envelopes the frame on all sides, encapsulating the frame and providing strength to prevent lateral tearing of the stretchable polymer 20. Central section 22 in the wagon wheel-shaped frame can be pierced by a needle and/or the wedge-shaped sections can be pierced to provide ports to the inside of the intraocular lens. Different shapes without spokes are contemplated. Alternatively, it is possible to use a stretchable elastomer coated with support polymer only on one side, with or without a central clearing in the support polymer.

A self-sealing valve can consist of a stretchable elastomer. Once a fluid injector is retracted from the stretchable elastomer, the latter self-seals, preventing leakage from the lens.

The thickness of a stretchable elastomer required to self-seal itself depends on the diameter of the fluid injector, the geometry of the stretchable elastomer, etc.

FIG. 10 is a chart illustrating experimentally determined thicknesses of a valves that self-seal the lens at different pressures. In the figure, data is charted from thin membrane seal testing with air on one side and water on the other side. A thin silicone elastomer membrane was sealed across a 1/16 inch diameter hole. Different diameter size hypodermic needles were used to pierce the center of the membrane. Next, a pressure differential was applied across the membrane and leakage of air was visually observed. The sealing pressure was defined as the pressure required for air to leak through the incision in the silicone membrane.

If a hypodermic needle is used, data similar to that of FIG. 10 can be used to pick the correct seal thickness for a given incision diameter. For example, if the membrane is circular and has a diameter of 1/16 inch, then for a 110 μm diameter needle to seal more than 2 psi air, the membrane thickness of 105 μm or more should be used.

The surgical time for lens removal and replacement is short and is often less than fifteen minutes. This is beneficial because faster procedures reduce postoperative complications, reduce overall procedure cost, and lower surgeon fatigue. Because the intraocular lens requires filling during the operation, it is important to reduce the overall filling time. In one embodiment, the lens system is intended to be filled in less than 60 seconds, for example, less than 20 seconds.

The speed at which the injectable accommodative intraocular lens is filled with fluid depends on the volume of the lens, the pressure differential being used to push the fluid through the fluid injector, the viscosity of the fluid, the geometry of the fluid injector, etc.

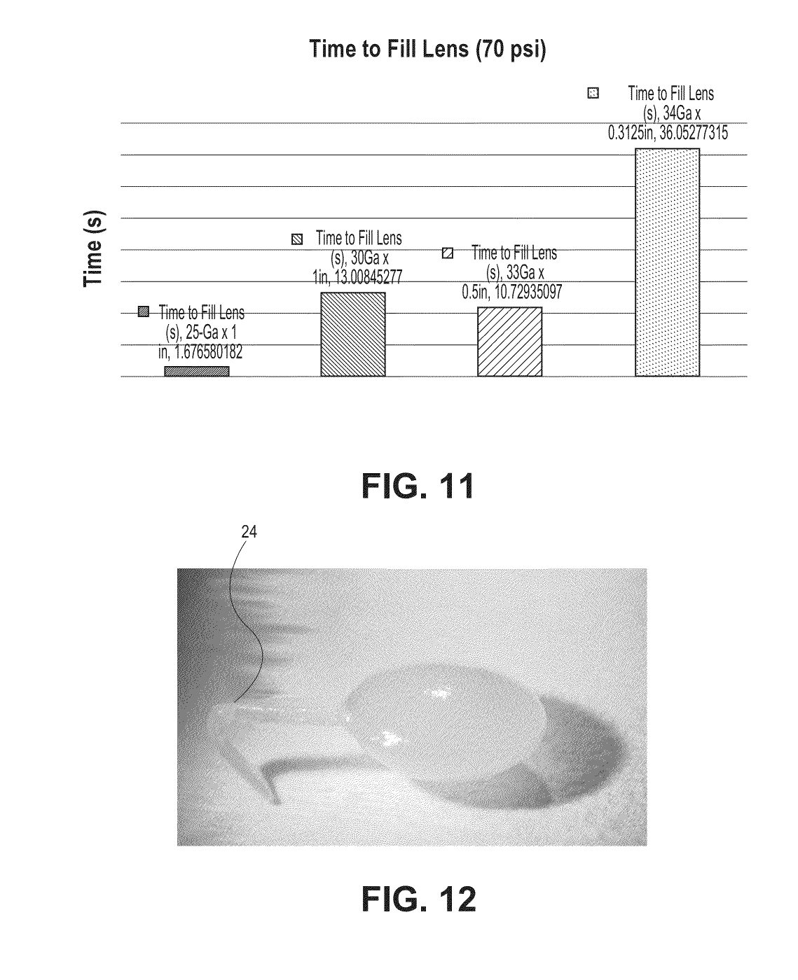

FIG. 11 is a chart illustrating commercially available hypodermic needle diameters found to fill injectable accommodating intraocular lenses in a specific amount of time. For the tests, 20 centistokes silicone fluid was used. The data is reported as the time (in seconds) to fill a human lens, which was estimated to have a volume of 160 mm³ with a driving pressure of 70 psi. Based on the sample data in FIG. 11, the geometries of the 25 Ga, 30 Ga, and 33 Ga hypodermic needles would all be acceptable for injection of the 20 centistokes fluid at 70 psi, while the 34-Ga needle geometry would not be acceptable because it requires over 20 seconds to fill.

A few methods of manufacturing the injectable accommodating intraocular lens are described for illustrative purposes. In one method, the lens shape is molded with a dissolvable material, such as a wax. Chemical vapor deposition of parylene is performed on the wax mold, making the shape of the lens. During the deposition process, the surface finish of the deposited material can be made smoother by using a light coating of a liquid to wet the surface of the wax mold. For example, dipping the wax mold in a polydimethylsiloxane (PDMS) fluid before deposition fills in slight surface roughness from the wax mold, creating a better optical surface for the lens.

FIG. 12 is a picture of a lens with an injection tube before dissolvable mold material has been removed in accordance with an embodiment. The wax mold is either supported by injection tube 24 or by a small needle. A silicone elastomer valve is placed on the side, either by placing a small drop of silicone elastomer and curing or by placing a cured silicone elastomer valve on the deposited parylene. A second chemical deposition of parylene is performed to encapsulate the valve. If an injection tube is used, it is then cut open distally from the lens, and the wax mold is dissolved out of the lens. The tube can be sealed by cautery or glue after dissolving the wax.

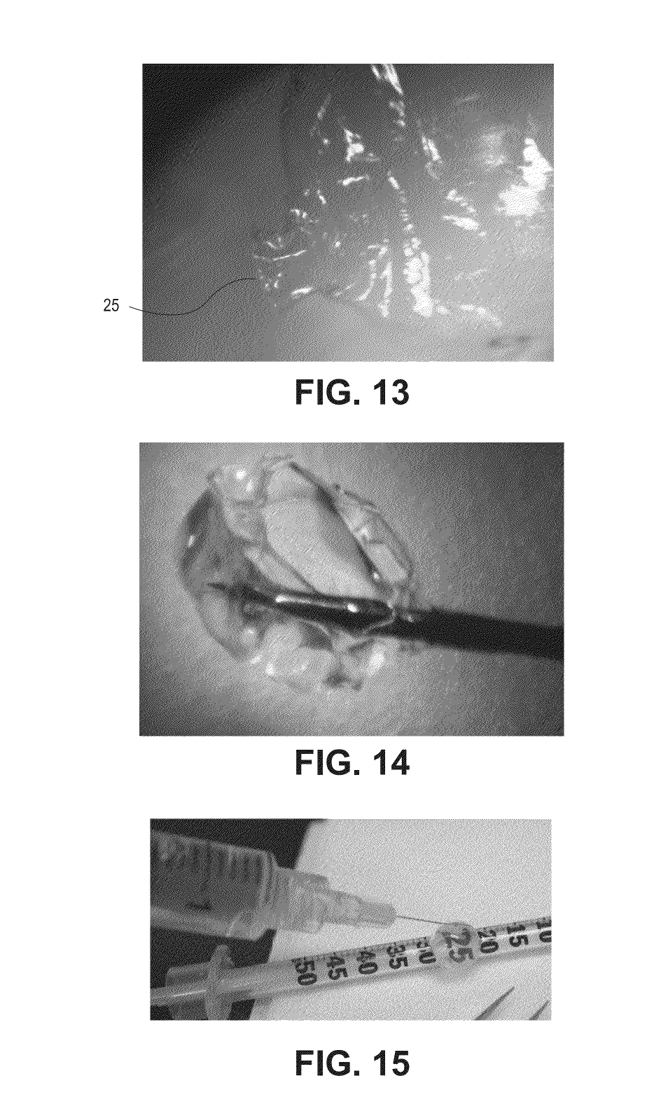

FIG. 13 is a close-up picture of a 1.5 μm thick parylene lens with its injection system cauterized at 25 in accordance with an embodiment.

Alternatively, a single chemical vapor deposition can be performed on the wax mold with the injection tube. A fluid injector is used to inject into the injection tube during insertion of the lens. When the lens is filled, the fluid injector is removed and the injection tube is closed off with cautery, glue, or other similar method and potentially cut off.

FIG. 14 is a picture of a lens with mold material dissolved and an injection system attached in accordance with an embodiment.

Likewise, parylene deposition can be done on the lens while it is either rolled, or levitated in the chemical deposition chamber. Next, the stretchable elastomer patch is placed on the deposited parylene, and a second parylene deposition is performed in a similar manner. Finally, the patch valve is opened by inserting the fluid injector or other instrument into the interior of the lens and the molding material is dissolved out.

### Further Manufacturing Techniques for Inner Mold

An outer shell can be produced for an implantable polymeric cavity. First, a mold form is fabricated in the shape of the interior of the desired implantable polymeric cavity. Next the mold is coated with a polymer. Non-limiting exemplary coating processes include spraying the mold, using a dispersant and allowing the dispersant to evaporate, chemical vapor deposition, and dip coating. If a curable polymer is used as the coating polymer, then the polymer is cured or partially cured with the mold inside. Exemplary curing techniques include heat, ultraviolet light, the passage of time (e.g., for a self-curing polymer), or allowing a dispersant to evaporate off. If chemical vapor deposition is used, the material may be reflowed following deposition onto the mold. The result of any of these processes is formation of a polymeric shell over the mold, which is removed without damaging the surrounding shell. One technique for removing the mold is to dissolve the mold material and allowing it to diffuse through the polymer shell; other techniques are described below.

A mold form can be coated with a polymer to form a shell, and a valve is fused to the shell. Application of the valve may occur during the polymer coating process, or it may be placed on the mold before it is coated. Exemplary methods of attaching the valve to the shell include chemical vapor deposition of a polymer, such as parylene, over the valve following placement thereof; gluing the valve to the shell using an adhesive; curing the valve in situ with an over-mold process; or using an elastomer, such as a silicone elastomer, to fuse the valve to the shell. In certain embodiments of the invention, the valve consists of or comprises a partially cured silicone, which is then fully cured along with the polymeric shell; in this manner, cross-linking of polymer chains between the shell and the valve occurs.

Following fabrication of the polymeric cavity, the valve affords fluidic access to the interior of the cavity. During device fabrication, an access instrument, such as a cannula, needle, or blunt tip, may be inserted through the valve in order to dissolve the mold, e.g., by injecting a solvent through the valve. Other techniques for eliminating the mold include allowing a solvent to pass through the polymer or increasing the temperature to a level that will melt the mold without damaging the polymer. The mold may be heated by, for example, local heating by injecting a hot fluid or gas, by heating the access instrument, or by global heating of a large section (or the entirety) of the device. Whether or not it is used to destroy the mold, the access instrument may be employed to remove the mold remnants by aspirating them through the valve. In some embodiments, the liquid contents are removed through the valve along the flow path. It should be noted that the mold may be porous, or it may be created to have a non-solid internal lattice structure to facilitate the injection of solvent and minimize the dissolution time.

A tube can be an integral part of the original mold. This portion is coated with a polymer and cured if required. Next, the polymer tube is used to aspirate the mold contents after they are melted or dissolved. In some embodiments a tube, such as a polyimide or silicone tube, is inserted into the mold. The polymer coats the tube and is cured to it. Thereafter, the tube can be left in place, closed off for curing, or cut off and replaced with a valve. In embodiments where the tube remains in place, the valve may be omitted.

The valve may be fastened to the polymer by applying an uncured polymer around the valve and then curing it, or simply by depositing a polymer on the valve to hold it in place; for example, parylene may be deposited using chemical vapor deposition to hold the valve to the polymer.

In some embodiments, the mold is created at cryogenic temperatures, for example below −150° C., −238° F. or 123 K. The polymer may be coated while maintaining the cryogenic conditions. Upon raising the temperature, the mold melts, evaporates, or sublimates. For example, water may be used at cryogenic temperatures to form the mold. Then parylene is coated using chemical vapor deposition, or a dispersant such as a silicone dispersant is used to coat the mold. At temperatures above freezing, the mold melts into water and may be removed, either by passing through the polymer walls or through a valve or tube. Alternatively, metals and polymers with low melting points, such as a Field's metal, may be used.

In some embodiments, a dissolvable wax mold is used to create the shape for a balloon intraocular lens. The wax mold is held with a small tube or string in a chemical vapor deposition chamber. Parylene is coated on the wax mold, and the tube is then cut off A valve is placed above where the tube was previously located. The valve may be formed from a silicone elastomer. Next, a second deposition of parylene encapsulates the valve. The valve is accessed using a cannula, and hot water is injected through the parylene balloon to melt the wax mold, which is thereupon aspirated through the cannula. In one implementation a two-chamber cannula is employed, with one of the tubes injecting hot water and the other aspirating the dissolved wax mold.

In some embodiments, a dissolvable mold is used to create the shape of a balloon with a tube connecting to the lens. A dispersant of silicone, such as a fluorosilicone, is used to coat the lens. The dispersant evaporates and the polymer is cured. A subsequent dip coating of the mold is performed with a different polymer, such as unsubstituted polydimethylsiloxane, which is thereupon cured. After this layered coating approach, the internal mold is dissolved and removed from the polymer balloon, creating a finished balloon intraocular lens.

The mold for the polymeric cavity can be manufactured from using a transfer molding process, by injection molding, or using three-dimensional (3D) printing. In certain embodiments of the invention, custom molds are made on a patient-by-patient basis. For example, a prosthetic implant such as a chin implant, breast implant, or calf implant may be made in a custom manner for each patient, using, for example, computer-aided design software. Then a 3D printer may be used to manufacture the custom mold. 3D printing technologies include but are not limited to stereolithography (SLA), fused deposition modeling, selective heat sintering, selective laser sintering, printer-based 3D printing, laminated object manufacturing, and digital light processing. In one embodiment, a 3D wax printer is used, and the wax is melted or dissolved following formation of the polymer shell.

Any of several techniques may be used to smooth the mold. Local heating can be performed to cause reflow of sharp edges from the printing process. Another approach utilizes polishing. If the polymer shell is applied by chemical vapor deposition, the mold can be coated with a non-volatile liquid to form a smooth surface. As an example, a wax mold can be lightly coated with silicone oil. Rough edges can be smoothed out by the non-volatile liquid, and a polymer, such as parylene, can be deposited onto the liquid coating the mold. In this manner, optical-quality surfaces can be created.

FIG. 15 is a picture of a parylene lens filled with 20 centistoke silicone fluid in accordance with an embodiment.

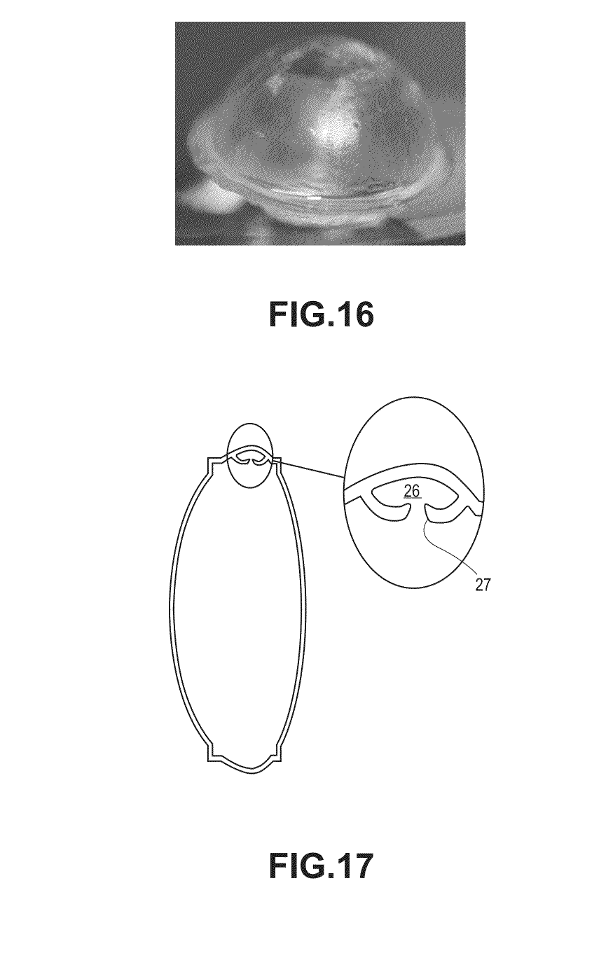

FIG. 16 shows an exemplary composite parylene on silicone lens. A 40-μm thick silicone lens was spin coated, and an injection site was molded to the lens. Next, the silicone surface was modified with reactive oxygen ions and then silanization to increase adhesion with parylene. Parylene was then deposited on the lens. The peripheral parylene was etched away with oxygen plasma, leaving a silicone lens covered with parylene along the central optical axis. A circular ring at the top of the image indicates the border of the parylene/silicone composite and the peripheral silicone.

FIG. 17 shows an exemplary air bubble-capture mechanism. Once air bubbles travel through inlet and one-way valve 27, they are captured in out pocket 26 area. Although the profile of the inlet 27 allows air bubbles to be captured easily, the profile of out-pocket 26 makes it difficult for the air bubble to return into the main body of the lens.

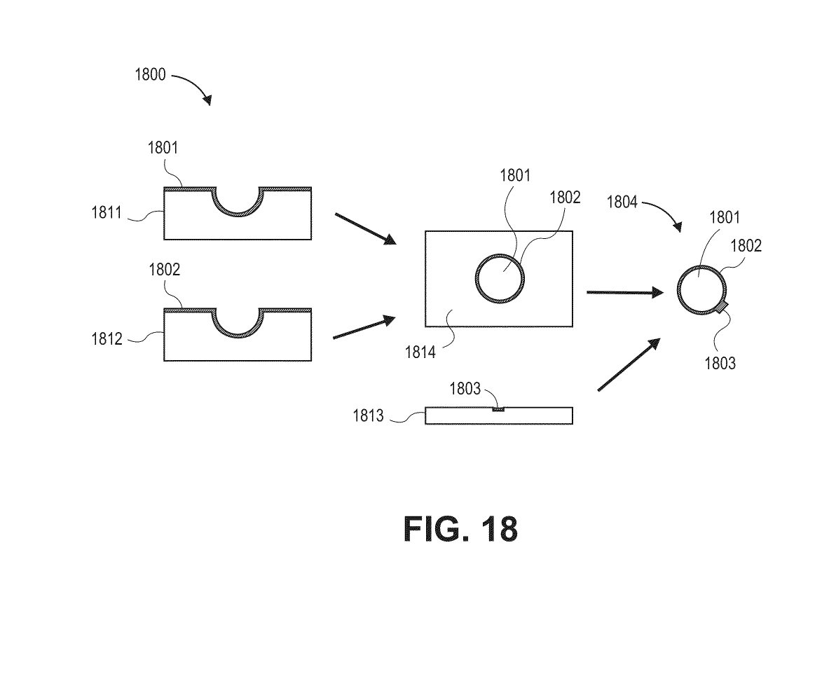

FIG. 18 illustrates a silicone intraocular lens manufacturing process using molds in accordance with an embodiment. A silicone elastomer such as NuSil MED4-4210 can be used to mimic the Young's modulus of a human lens capsule. In this case, the Young's modules of silicone is 1 MPa as compared with 1.5-6 MPa in a natural human lens. A capsular thickness of 30 μm is formed in silicone as compared with 3-21 μm in a natural human lens.

In manufacturing process 1800, the lens body is fabricated by spin coating silicone elastomer 1801 and 1802 on molds 1811 and 1812, respectively. One mold corresponds to the anterior half of the lens; the other mold corresponds to the posterior half of the lens.

After spin coating, the two halves 1801 and 1802 are clamped and fused together in device 1814 and placed in a convection oven to cure.

Microelectromechanical systems (MEMS) refill valve 1803 is fabricated by molding a colored or clear silicone patch in a 250 μm thick SU8-100 mold 1813. Patch 1803 is peeled from the mold and attached to lens 1804 using adhesive to anterior segment 1801 of the lens. After attaching the MEMS refill valve to the lens, an incision is made in the refill valve to allow silicone oil to be injected into the body of the lens after surgical implantation.

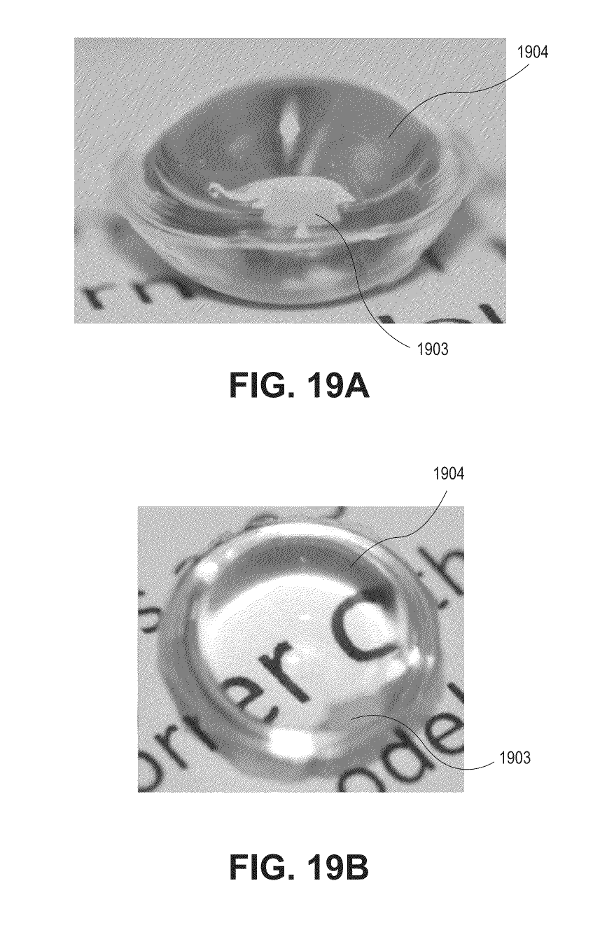

FIGS. 19A-19B are pictures of a 30 μm silicon elastomer shell fused on two halves around the equator and entry valve in accordance with an embodiment. A (square) rectangular entry valve patch is colored yellow so that a surgeon can easily locate it. A circular shape can also be used, among other shapes. Patch 1903 has an innermost edge (toward the center of the lens) that is concave, specifically shaped as an arc with a center corresponding to the central axis of the lens. This provides an unobstructed circular clear aperture of the lens.

### Further Manufacturing Techniques for Outer Mold

Some manufacturing methods can create a flexible implantable reservoir with controllable features and which can produce superior surface finishes, controlled thicknesses, and high optical quality. Techniques in accordance herewith can utilize properties of the uncured monomer, adhesion of the uncured monomer to the wall of the mold, and the viscosity and position of the mold relative to gravity. By using a monomer or silicone with the appropriate viscosity, correct adhesion to the mold, and layer thickness, it is possible to have the uncured polymer move very little relative to the mold after the mold has been spin coated. This can ensure that the polymer will not significantly flow and thus retain a natural, distributed state during the curing process. This can be useful for coating the mold (by spinning) and then curing the mold without having to spin during the curing process.

A simple Navier-Stokes analysis, assuming incompressible viscous fluid flow, illustrates the dynamics of movement of the uncured material relative to the wall of the mold. The velocity, u, of a fluid down an inclined plane under gravitational force can be expressed as:

$$u = \frac{ρ g sin α}{2 μ} z ( 2 H - z )$$

where g is the gravitational acceleration, a is the angle of the inclined plate, μ is the dynamic viscosity of the fluid, z is the height of the flow being examined from the surface of the plate, and H is the total height of the fluid flow. At the boundary of the inclined plane flow velocity is zero. The maximum flow rate occurs at the top surface of the flow (the interface with air) where z=H. Assuming a vertical wall as a worst case situation, sin α→1. The maximum flow is then given by:

$$u = \frac{ρ g}{2 μ} {H}^{2}$$

As a first-order calculation, the maximum allowable flow distance consistent with a uniform coating can be calculated by multiplying velocity by time. In reality, more complex models using a variable viscosity can employ integration in order to determine actual flow rate. The viscosity change with time is related to the heat transfer and cure properties of the coating material. Therefore, this type of processing often requires high-viscosity monomers, ideally over 6000 centipoises when targeting a coating thicknesses under 150 μm and most preferably between 20 μm and 50 μm.

In some embodiments in which the material is spin coated onto the mold, high-viscosity coatings, over 6,000 centipose, are used. Nominally these spin rates are over 1,000 rpm, and preferably in some cases the spin coat rate is above 6,000 rpm. In certain embodiments of the invention the spin rate is between 6,000 rpm and 20,000 rpm. Lower spin rates can be achieved if the uncured monomer is diluted with a volatile solvent, such as hexane or heptane, or if a dispersant is used. Upon spinning the mixture onto the mold, the solvent evaporates, leaving a higher-viscosity monomer. For example, a spin rate of 500 rpm can be used with a fluorosilicone dispersant. During the spin process, the volatile component evaporates, while the fluorosilicone remains. The viscosity of the fluorosilicone is high enough to prevent significant flow of the material during the curing process.

In some embodiments, the two mold halves are clamped together, and a slight spin is induced to move a precise amount material toward the equator of the mold. During the curing process, the equatorial portions of the material flow faster than other areas, reducing the equatorial thickness, making the mold uniform. Specific speeds for rotation and motion can be calculated for a specific material as described above for precise coating.

### Manufacturing of a Silicone Balloon Shell

The ensuing discussion focuses on silicone, but it should be understood that the principles are applicable to other elastomeric polymers.

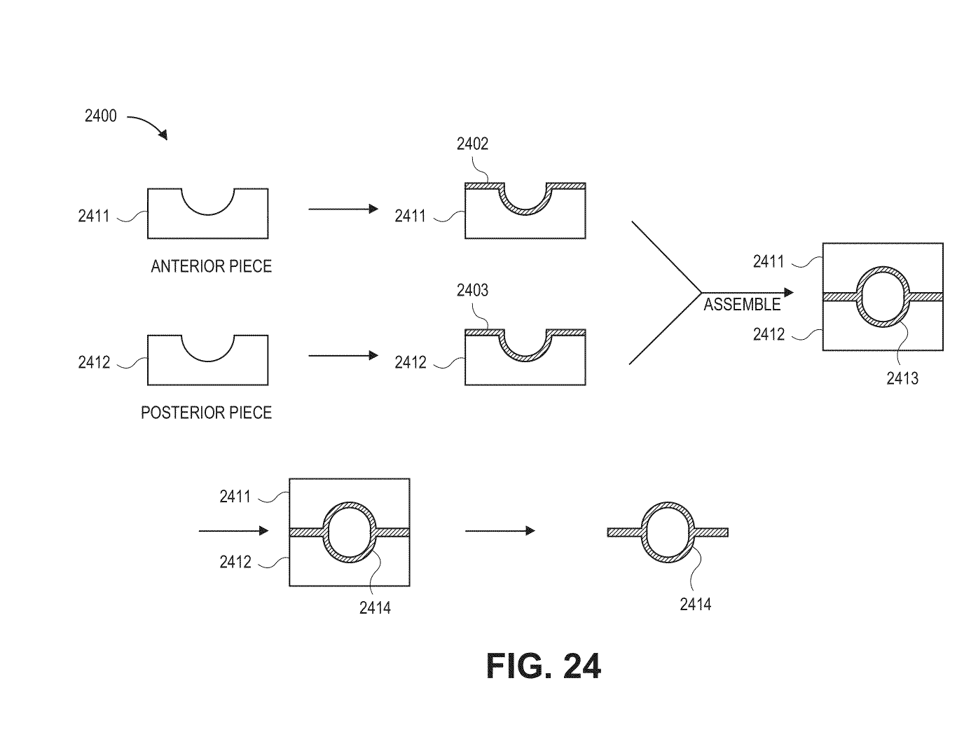

FIG. 24 illustrates a representative procedure for manufacturing a silicone balloon in accordance with an embodiment. Two mold halves are used, namely, an anterior cavity 2411 and a posterior cavity 2412. A thin layer of silicone 2402 and 2403 in liquid form is spun on each of the mold halves. High-viscosity silicone may be used so the thin-layer can stay on the mold without breaking. The two mold halves are then assembled together to form a complete, uncured balloon 2413. The complete, uncured silicone balloon is cured in the mold by thermal curing, UV exposure, or other methods of curing silicone known to those skilled in the field. During the curing process, the silicone is converted from liquid into a solid form. The cured silicone balloon 2414 is then released from the mold.

In some embodiments, the spinning step and the curing step are performed separately. In this way, the spinning process that determines the thickness of the balloon and the curing process that determines the mechanical modulus of the balloon can be individually optimized. The thickness of the balloon shell can be determined primarily by three parameters: the viscosity of the silicone material, the spinning rate, and the spinning time. During the curing process of silicone, the monomers form long-chain polymers, and therefore the viscosity of silicone continuously increases until all monomers are fully polymerized. By separating the curing step from the spinning step, these two steps may be optimized individually. For example, a spin time of 2 minutes may be used to obtain a desired lens shell thickness, while a curing time of 30 minutes may be used to obtain desired physical properties.

Separately performing the spinning from the curing step can be a tremendous advantage over the spinning while curing. If spinning while curing is used, then the length of spin time is typically equal to the cure time, usually over 10 minutes. In the above case, one can spin for shorter amounts of time, e.g., 10 seconds, and then cure separately.

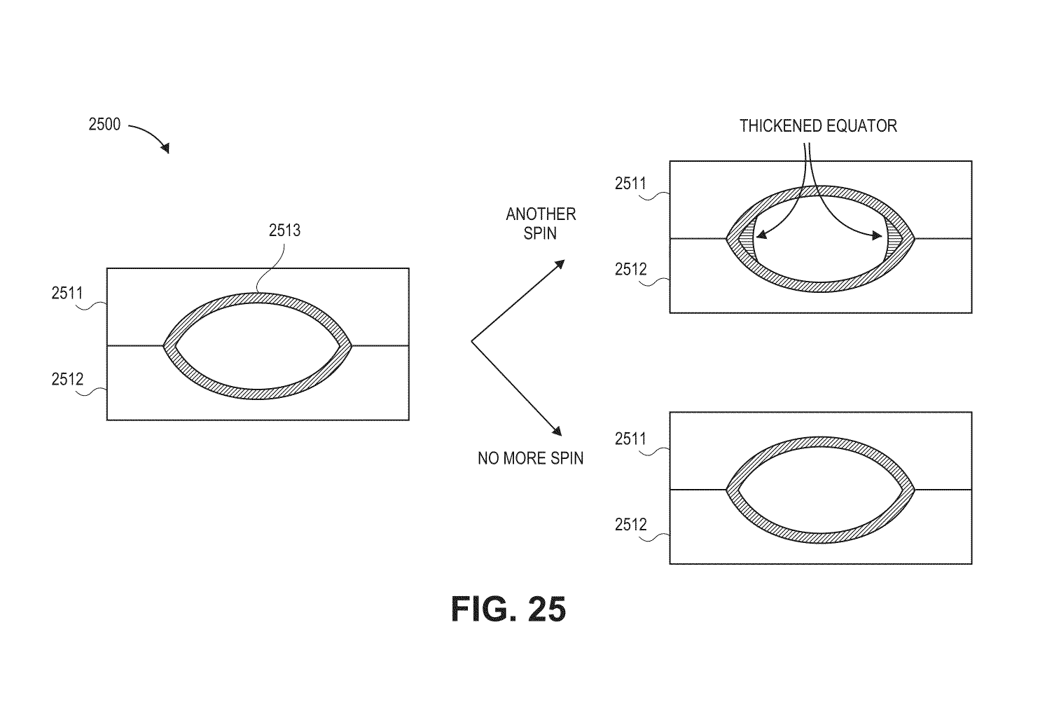

As illustrated in FIG. 25, in some embodiments, no more spinning is required after the two mold halves are assembled together. Curtailing spinning permits the thickness of the balloon equator to be reduced. During spinning, centrifugal force spreads the silicone out from the spinning center toward the edge. In an open-top mold, the silicone would spread out and leave the mold. In an enclosed mold, however, the silicone accumulates at the equator of the mold as it spreads out, forming a thickened equator after the spinning step, as shown in the figure. By reducing or eliminating the spinning step after the molds are enclosed together, the thickness of the equator can be reduced and the fabricated silicone balloon has higher flexibility, which is advantageous in applications such as an accommodating intraocular lens.

### Manufacturing a Built-in Valve in the Silicone Balloon

In order to build the access valve into the silicone balloon, at least two different schemes can been employed.

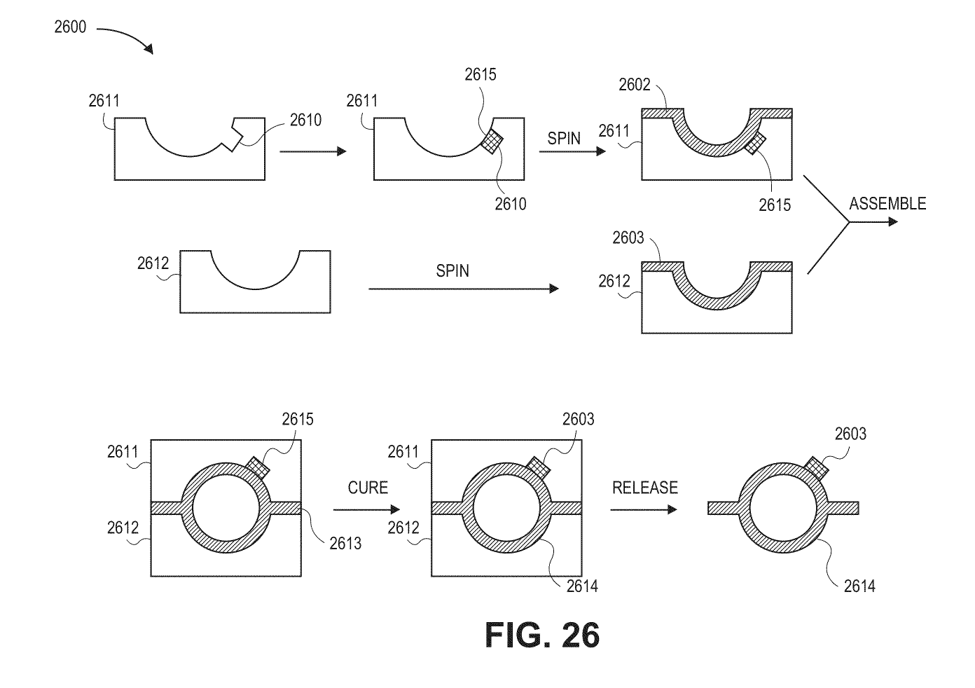

FIG. 26 illustrates a first scheme 2600 in which a recess area 2610 with a pre-designed shape is built into anterior mold piece 2611. A pre-manufactured valve 2615 matching the recess shape 2610 is placed into the recess before the silicone spinning step (step 2, FIG. 24). After the spinning step, a thin layer of silicone 2602 is formed on the mold surface, covering the valve piece 2615. For example, the pre-manufactured valve 2615 may be made of silicone and not fully cured before loading into the mold. During the curing step, cured valve piece 2603 is fused with the silicone thin film and formed the final device 2614.

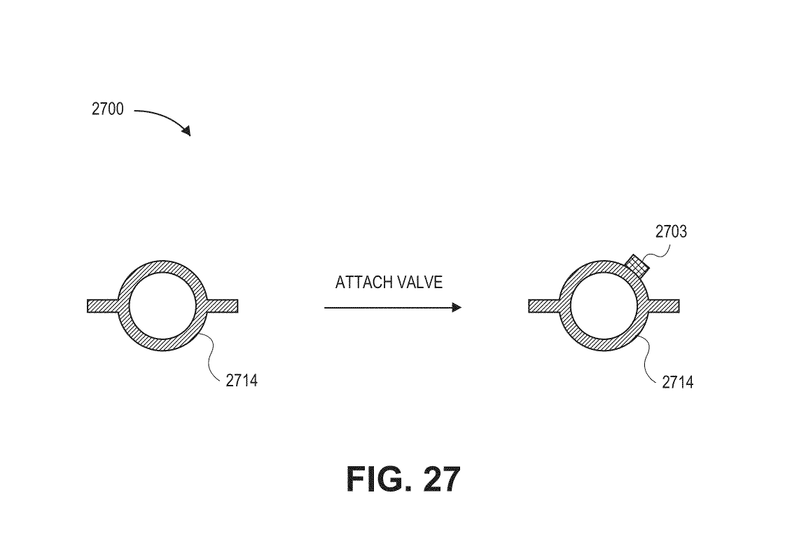

FIG. 27 illustrates a second scheme 2700 in which a valve 2703 is attached to a cured silicone shell 2714 after that the shell is released from the mold (see step 5, FIG. 24). The valve 2703 can be adhered to the silicone shell in any of various ways, e.g., applying a thin layer of adhesive such as epoxy to the valve-shell interface, applying a thin-layer of uncured silicone to the valve-shell interface and curing to form a solid bond, etc.

A novel aspect of some embodiments of the manufacturing process is that spinning after the two mold pieces are assembled together is optional. Because of this improvement, more configurations of valve designs may be incorporated in a silicone balloon design.

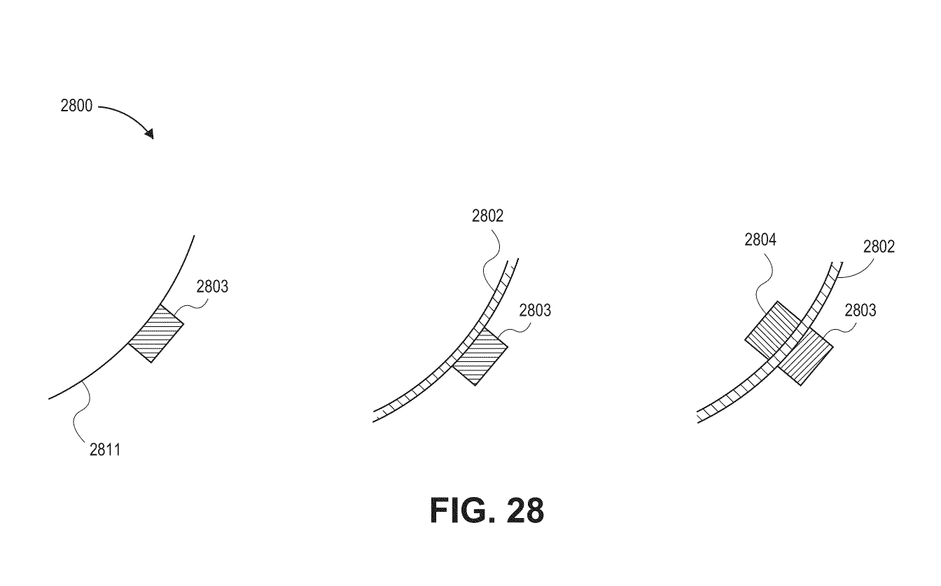

FIG. 28 illustrates a two-piece valve configuration in process 2800. In this configuration, a first piece of valve 2803 was put into the valve recess of mold surface 2811 before silicone spinning (e.g., illustrated in step 1 of FIG. 26) to distribute silicone 2802. After the spinning (e.g., step 2 of FIG. 26), a second valve 2804 piece may be placed on top of the first valve piece and adhered to silicone film 2802. After the curing step (step 4 of FIG. 26), the valve pieces are fused into the silicone shell and form the solidified silicone balloon.

This valve configuration may not be feasible if additional spinning steps were performed after the mold pieces were assembled together. For example if additional spinning steps were performed, centrifugal force would move the second valve piece 2804 away from the first valve piece 2803, causing the alignment of the two valve pieces to be broken.

The above-mentioned two-piece valve configuration can be advantageous in applications such as intraocular lenses. By minimizing the thickness of the first valve piece, the balloon outer surface may be optimized to be flush with the surface. This can be important for the intraocular lens implantation, because a protruding valve would increase the risks of rubbing again the iris or surrounding tissue, possibly causing glaucoma, after implantation. Meanwhile, the overall thickness of the valve may be increased by the second valve piece. A thickened valve may provide a higher sealing pressure for the liquid-filled reservoir to hold the liquid contents, especially in the scenario of an increased internal pressure as experienced by the intraocular lens during accommodation.

### Remove Excessive Silicone Around the Balloon Edge

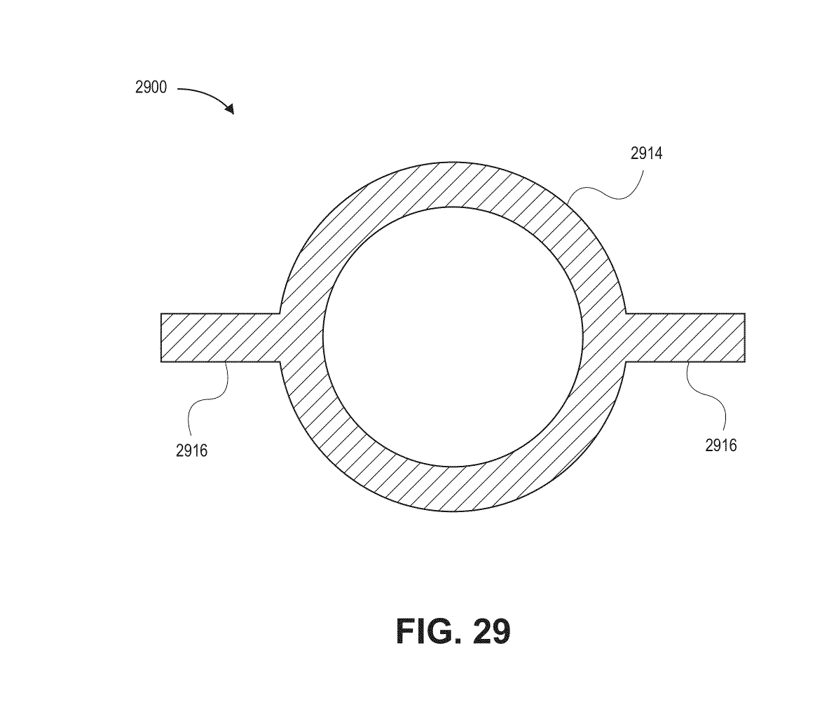

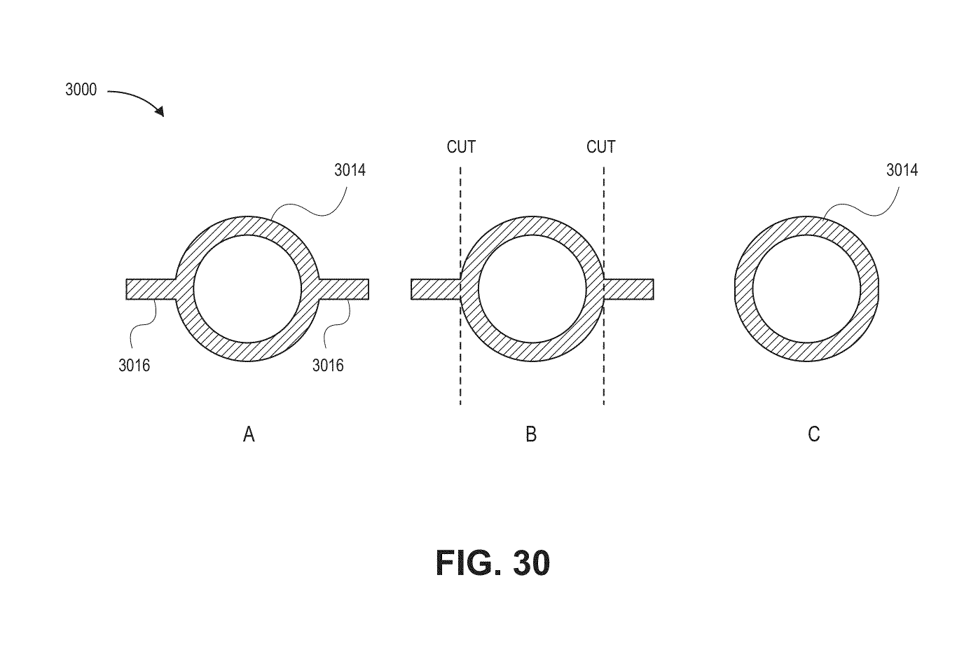

FIG. 29 illustrates an undesired edge around a freshly cured balloon.

During the spinning process, as illustrated in step 2 of FIG. 24, the formed silicone thin film covers the entire top surface of the mold. Therefore, the as-fabricated device, as shown in step 5 of FIG. 24, not only includes the desired silicone balloon 2914 but also includes undesired edge 2916 around a circumference of the balloon. The undesired edge is due to excessive silicone on the mold top surface.

Different methods can be used to minimize or remove this edge.

FIG. 30 illustrates removing the edge of the cured balloon by mechanical cutting, laser cutting (e.g. Nd:YAG, femtosecond laser, CO2 laser, UV laser, etc.), chemical etching, or other methods.

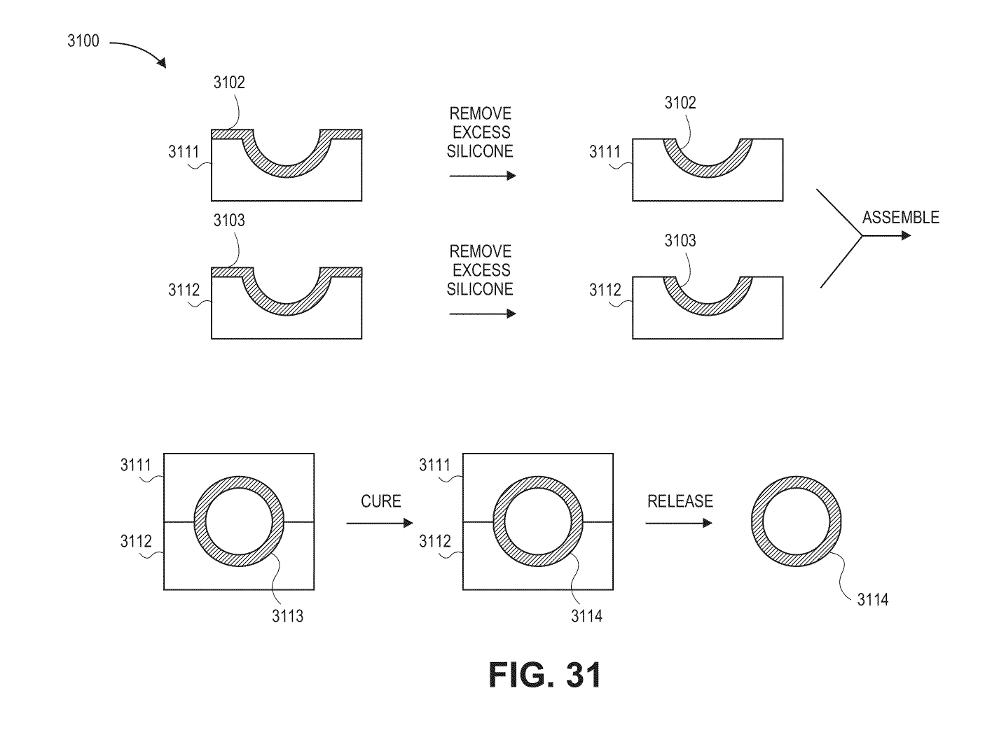

FIG. 31 illustrates another approach to removing the edge of the cured balloon. This approach includes removing the excess silicone of 3102 and 3103 on non-functional areas of molds 3111 and 3112 (such as the mold alignment surfaces and fastening surfaces) after the spinning step (step 2 in FIG. 24) and before the two mold halves are assembled together (step 3 in FIG. 24) into uncured balloon 3113. After the spinning step, the excess, uncured silicone on the top surface of the mold may be removed by manual scraping, sponge removing, laser cutting, chemical etching or other methods.

Alternatively or in addition, the mold may be masked with tape or an alternative removable surface applied by any suitable masking technique. This may prolong the life of the mold and prevent buildup of silicone on non-functional areas, which could compromise the cavity shape. After curing, cured balloon 3114 can be released from the molds.

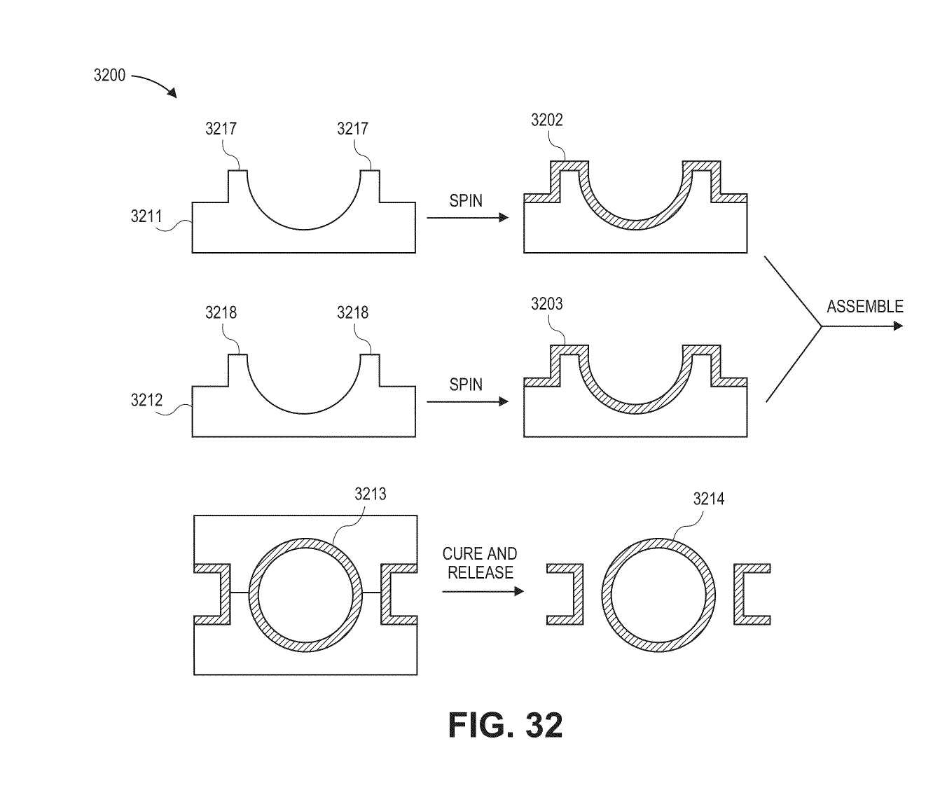

FIG. 32 illustrates a pinch-off mold design. Pinch-off protrusions 3217 and 3218 are protruding, thin rims around the edges of balloon molds 3211 and 3212, respectively. When the two mold pieces are assembled together, the rim enters the opposite mold piece, excising the silicone edge and leaving uncured balloon 3213. Each rim may be a raised section of flat surface with a thin thickness (e.g., 0.0004 inch), a sharp blade, or other protrusion.

A flat, raised thin section has the advantage of cutting the silicone edge but not causing damage to the mold. Such reusable molds may be made of stainless steel. A sharp blade design may be useful for a mold made of softer material, such as a disposable mold made of plastic. A mechanical force may be applied to the mold to further improve the cut. After the silicone is cured and the balloon 3214 is released, the as-fabricated balloon has a clean edge without excess silicone, because the excessive silicone ring has been separated from the balloon by the edge blade.

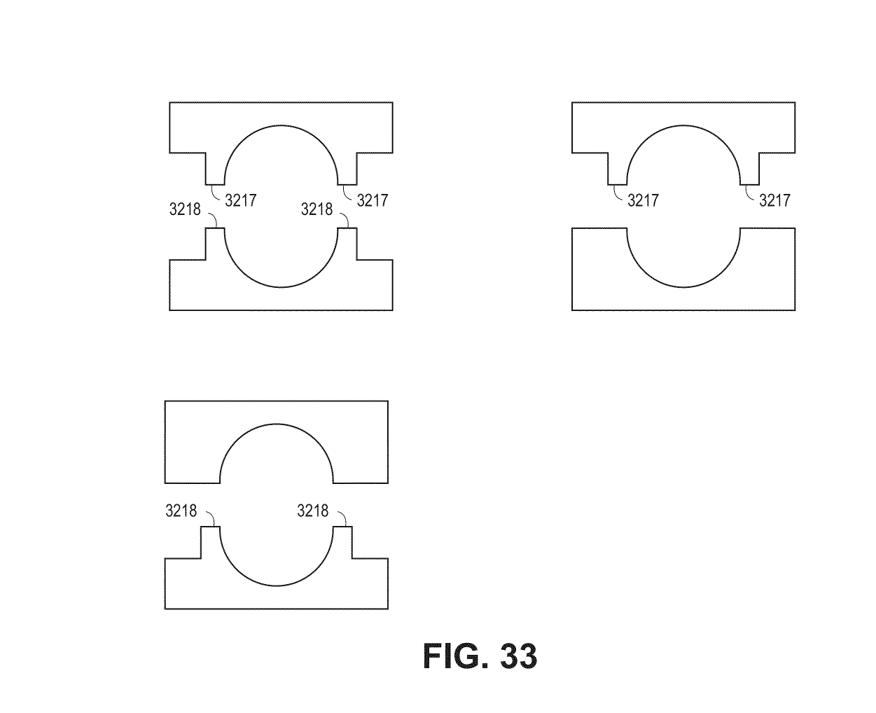

FIG. 33 illustrates three different pinch-off blade mold configurations that can be used in the manufacturing process. For example, pinch-off blade 3217 may be disposed in the anterior piece of the mold alone, in the posterior piece of the mold alone (e.g., pinch-off blade 3218), or in both the anterior piece and the posterior pieces of the molds.

### Aligning the Anterior and Posterior Mold Pieces

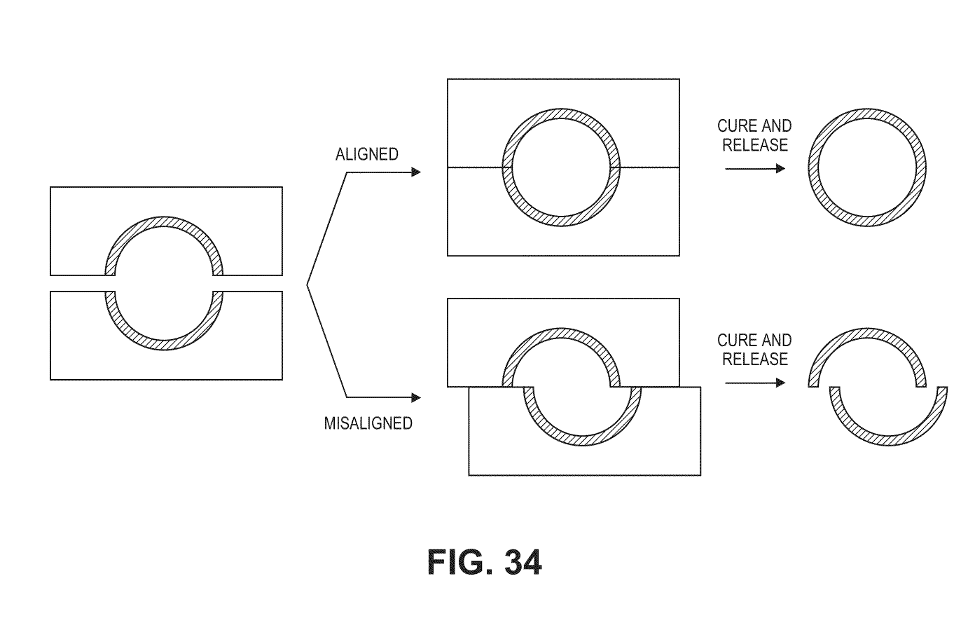

FIG. 34 illustrates a misalignment of molds. A silicone balloon may be formed by mating the anterior mold and the posterior mold. To improve the flexibility of the balloon, the thickness of the balloon shell is usually thin. Therefore, the alignment between the anterior and posterior molds may be critical. For example, if the balloon thickness is 50 μm, then a misalignment of more than 50 μm would lead to breakage of the balloon, as illustrated in the figure.

Different approaches may be used to control the alignment of the anterior and posterior mold pieces.

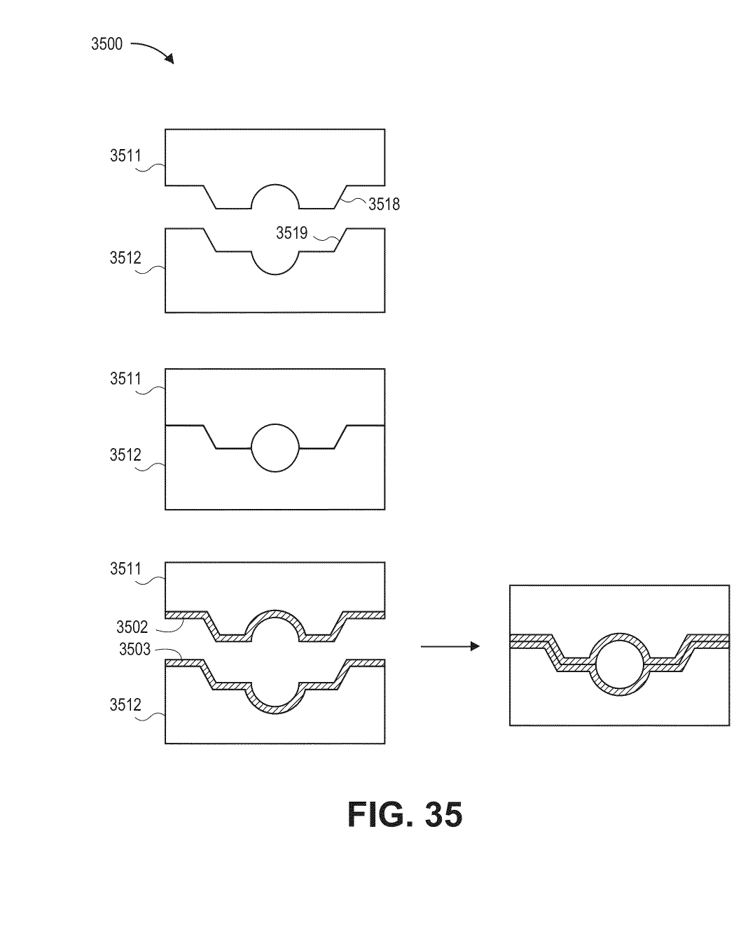

FIG. 35 illustrates an example of a convex slope or contour 3518 on anterior mold 3511 and a complementary concave contour 3519 on posterior mold 3512. By matching the profile of the convex contour and the concave contour, the two mold halves naturally align according to the profile accuracy of the contours.

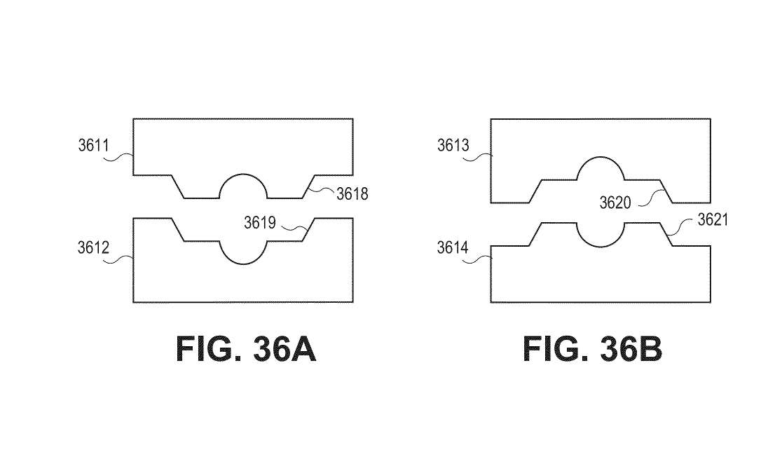

FIGS. 36A-B illustrate that the orientation of the convex and the concave contours may be switched between the anterior and the posterior mold pieces. For example, in FIG. 36A anterior mold piece 3611 has a convex mating surface 3618 that mates with a concave mating surface 3619 of posterior mold piece 3612. Alternatively, in FIG. 36B anterior mold piece 3613 has a concave mating surface 3620 that mates with a convex mating surface 3621.

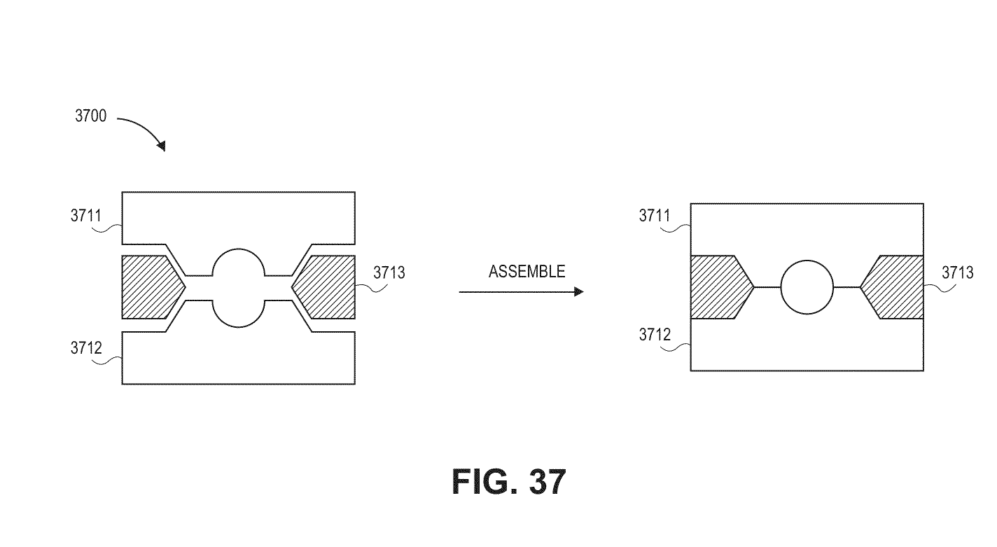

FIG. 37 illustrates another embodiment to align mold pieces. In this embodiment, both anterior mold 3711 and posterior mold 3712 have a convex contour. An extra outside ring 3713 with matching concave contour is clamped to the mold pieces to provide the alignment.

### Applying Release Reagent

Due to adhesion between the silicone material and the mold, a cured balloon may stick to the mold and become difficult to release. Breaking the adhesion increases the risk of damaging the integrity of the balloon and causing leakage of the liquid-filled reservoir.

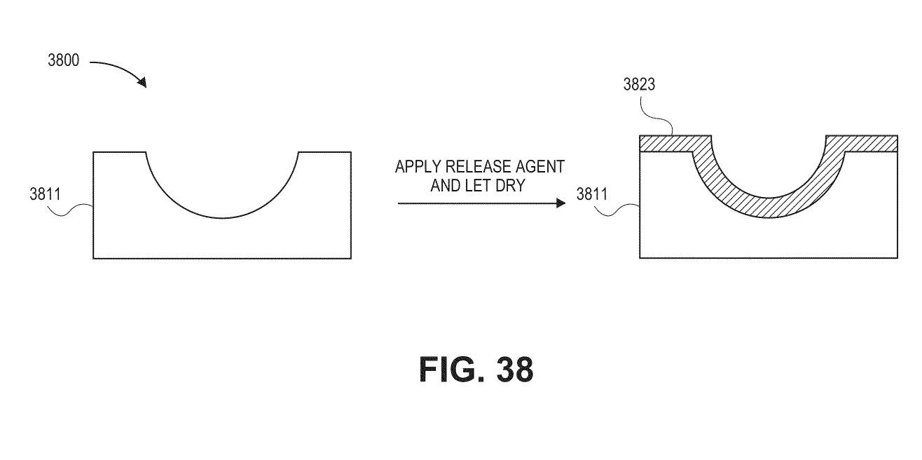

FIG. 38 illustrates using a release reagent to reduce the adhesion between the silicone and the mold. The release reagent is applied to the mold 3811 before silicone spinning (e.g., step 2 in FIG. 38). A layer of release reagent is applied to the mold surface and dries to form a thin layer 3823, which reduces the adhesion of the silicone to the mold during the manufacturing process. For each manufacturing batch, a new layer of release reagent may be applied to the mold surface. After each manufacturing batch, the mold may be cleaned to remove the release reagent. The thickness of the release reagent may be controlled to be thin, as so not to affect the profile of the molded balloon. The uniformity of the release reagent layer may be important to improve the surface smoothness of the molded balloon. Some release agents include soap solutions, detergent solution, or polyvinyl alcohol (PVA).

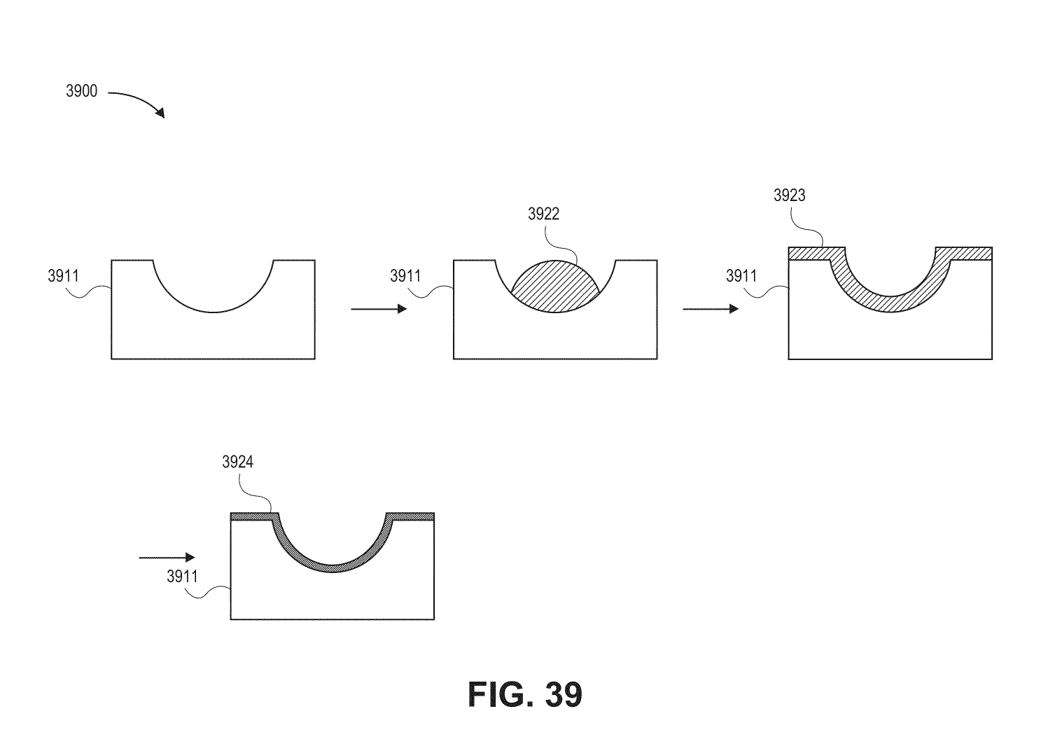

FIG. 39 illustrates a spin coating process in accordance with an embodiment. This can improve the uniformity of the release reagent layer. In this process, a predetermined amount of the release reagent solution 3922 is sprayed or dabbed on top of the mold 3911 in a localized area around a central axis. A high rate of rotation causes the release reagent solution to spread into a thin film 3923 with uniform thickness. The layer can be then air-dried to create dried release film 3924, which is ready for the silicone molding process.

### Off-Axis Spin to Reduce Equator Thickness

An equator of a silicone balloon behaves as a restraining ring when the balloon is expanded in volume. Reducing the thickness of the equator decreases the effects of this restraining ring and increases the capacity of the balloon to expand.

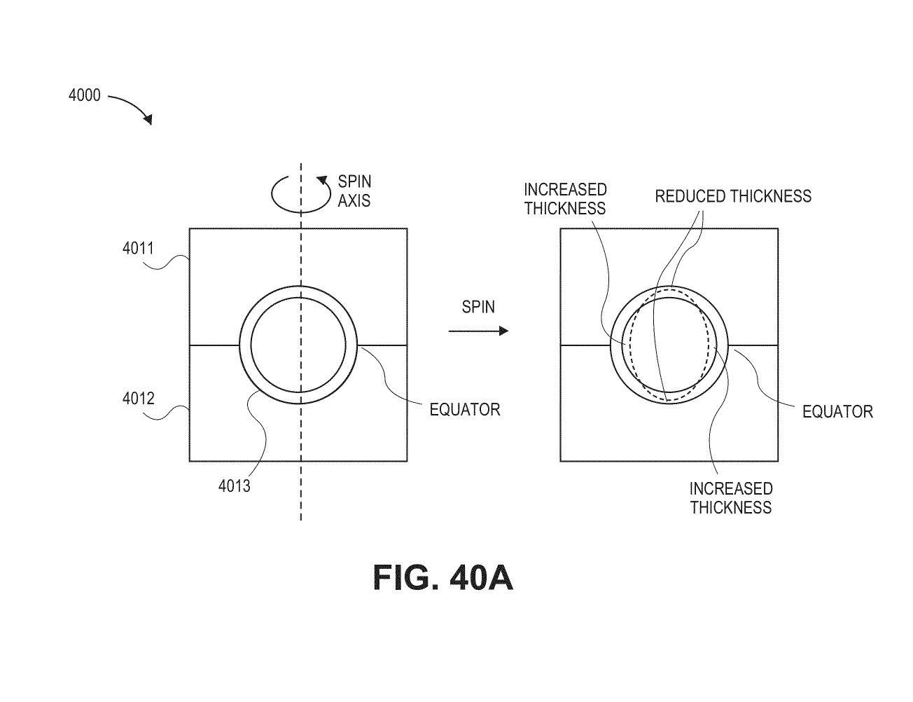

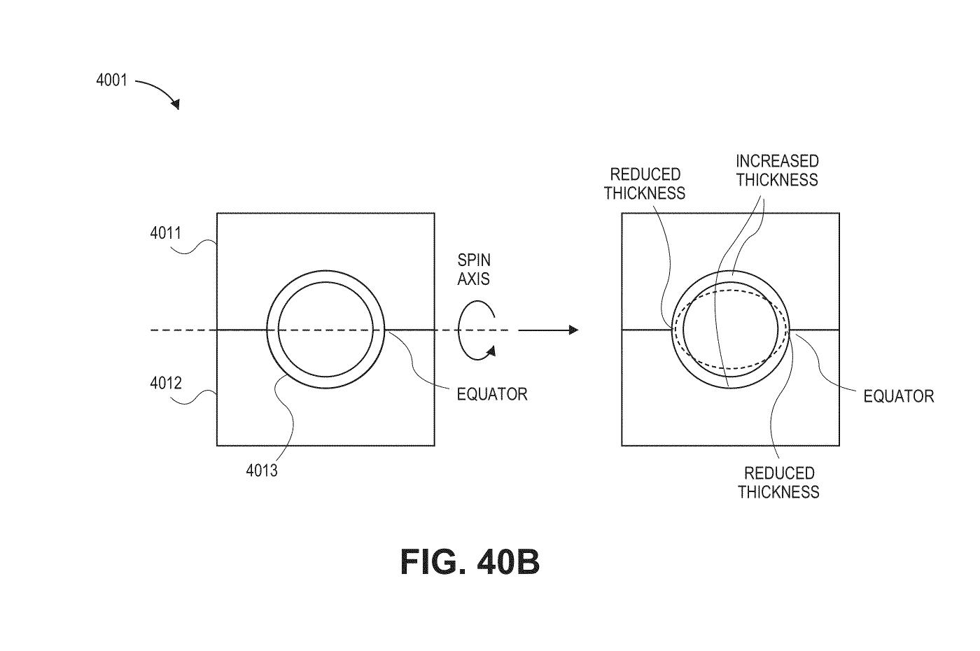

FIGS. 40A and 40B illustrates an off-axis spin step that may be used to reduce the thickness of the balloon equator.

After two mold 4011 and 4012 pieces are joined, a second step of spinning can be performed to further redistribute the uncured silicone along the mold surface. Two different ways of spinning may be carried out.

In the embodiment of FIG. 40A, the assembled mold is spun around the center axis of the mold so that the spin axis is perpendicular to the equator. During spinning, centrifugal force spreads the uncured silicone from near the spinning axis toward the edge so that it accumulates around the equator. Therefore, following spinning, the equator has a thickened portion of silicone.

In the embodiment of FIG. 40B, the assembled mold is spun around an axis off the center, for example, parallel or perpendicular to the equator plane. In this approach, centrifugal force spreads the uncured silicone from near the spinning axis, which is the equator portion, toward the edge. Therefore, after the off-axis spinning, the equator has a reduced thickness of silicone.

Different off-axis angles may be selected to optimize the thickness of the equator. Additionally, different axis spin combinations and intermediate targeted curing steps may be used to create different silicone thicknesses throughout the balloon surface and create specific flexibility biases. This may be beneficial in maintaining certain shapes such as with breast implants or toric intraocular lenses.

Furthermore, an optical inspection tool may be used to monitor thickness. The inspection tool may be automated and incorporate feedback with spin speed and/or time of spinning to alter the thickness in various portions. Once the thickness is within the desired range, the spinning process is stopped. Then, the two halves of the mold are combined and the silicone is cured as described above.

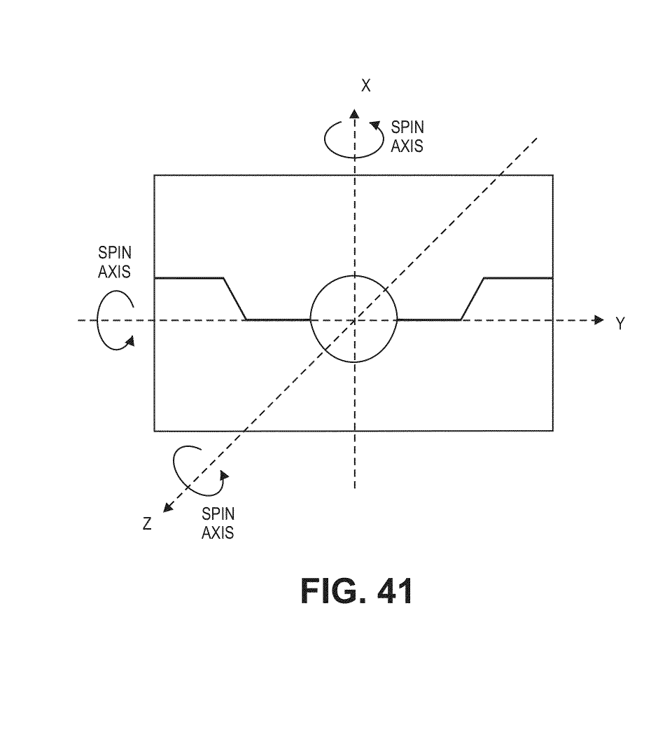

FIG. 41 illustrates a mold being spun around two or three axes simultaneously. For example, the mold may be spun around both the x-axis and the y-axis simultaneously. Alternatively, the mold may be spun around the x, y and z axes simultaneously. Simultaneous spinning may be achieved using an external fixture (e.g., a gimbal set), and helps to improve the silicone film thickness uniformity.

Other techniques of coating the mold with silicone thin film may also be used. For example, silicone in liquid form may be coated onto the mold by a spray coating process, where the mold may be rotated continuously during the spray coating process to increase the thickness uniformity. Alternatively, the silicone may be dissolved in a dispersant and coated onto the mold surface. After the dispersant evaporates, a thin layer of silicone forms on the mold surface. A dispersant can also be spun on the mold. During the spinning process the dispersant evaporates, forming a more uniform thickness across the mold.

The silicone layer may also be formed by a combination of spinning, spray and/or use of a dispersant. For example, first, one layer of the silicone may be coated onto the mold. At this point the first layer can be cured, fully or partially. Second, another layer of silicone may be coated (by spinning or otherwise) on top of the previously formed silicone layer. In this way, multiple silicone layers with different silicone materials may be formed.

A mold may be made of any suitable material. For example, the mold may be made of stainless steel to allow it to have greater reusability. Alternatively, the mold may be made of inexpensive plastic in order to allow it to be characterized as disposable. After curing, the halves of a disposable mold may be cut open to release the balloon or dissolved to release the balloon.

### Surface Treatment of Silicone Balloon

Following release of the silicone balloon from the mold, an additional surface treatment may be applied to modify the surface property of the balloon. For example, a layer of parylene may be coated onto the surface of the balloon to change its permeability. As those skilled in the art will appreciate, the term “parylene” encompasses a variety of chemical-vapor-deposited poly(p-xylylene) polymers. Parylene has a lower permeability to liquid or gas compared to silicone. Therefore, by coating a layer of parylene on the surface of the silicone balloon as a barrier layer, the permeability of the silicone balloon may be reduced. Moreover, by coating the silicone with parylene, the small pores intrinsic to the silicone membrane can be filled and closed. Parylene deposition may be performed by thermally vaporizing the parylene monomer and allowing the vaporized monomer to condense on the coating surface to form a polymer membrane.

Alternatively or in addition, a plasma treatment (e.g., with an oxygen or ammonia plasma) can be used to modify the surface of the silicone balloon. The cured silicone is hydrophobic by nature. By treating the silicone with oxygen plasma, the hydrophobicity of the silicone surface may be reduced or even converted to hydrophilic affinity.

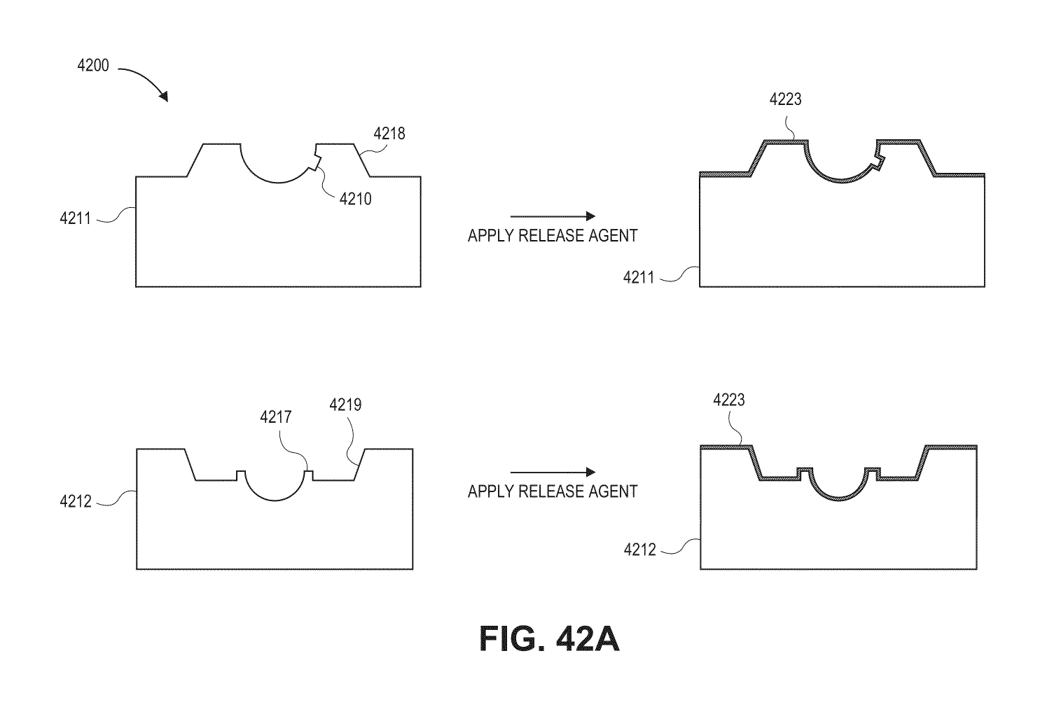

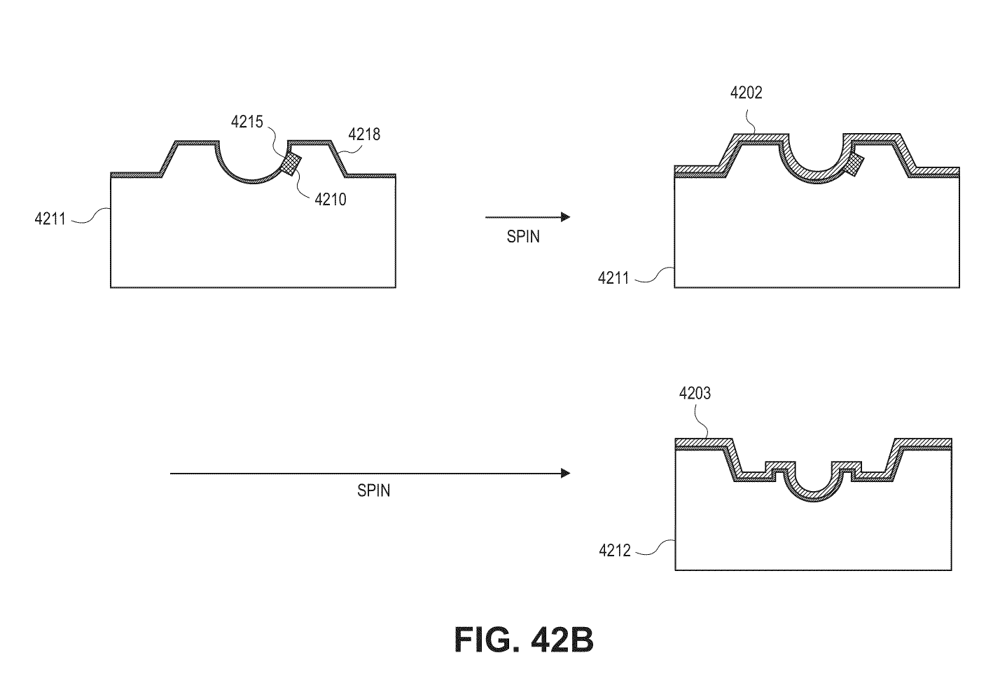

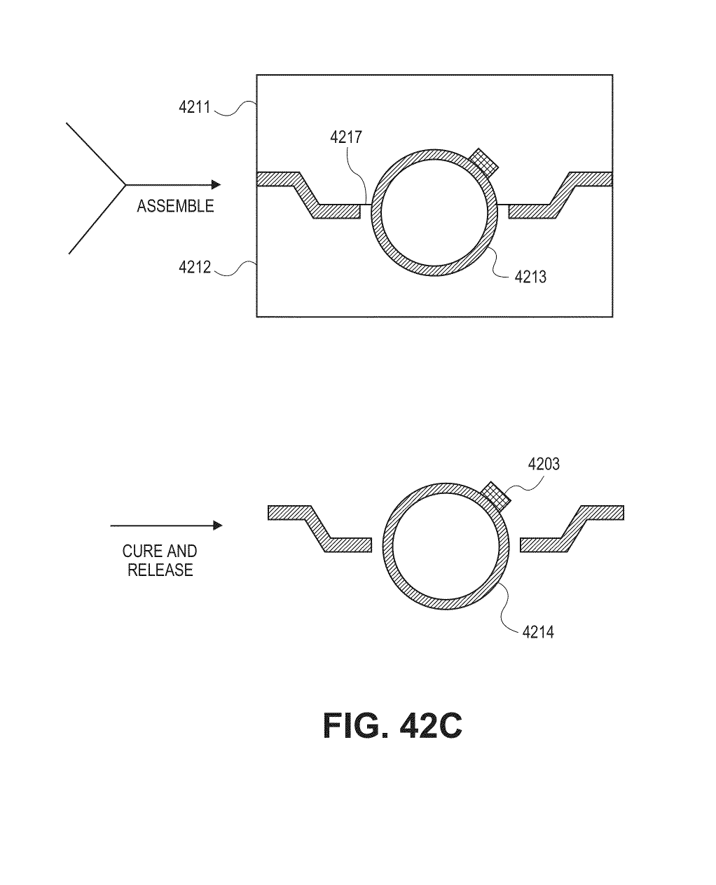

FIGS. 42A through 42C illustrate a representative manufacturing procedure to fabricate a silicone balloon with a built-in valve. The process begins with a pair of mold halves, i.e., an anterior mold piece 4211 and a posterior mold piece 4212. The anterior mold piece has a recess 4210 to permit loading of a valve and a convex contour 4218 for mold alignment. The posterior mold piece 4212 has a concave contour for mold alignment and a pinch-off blade 4217 for removing the edge of the silicone balloon.

In FIG. 42A, the molds 4211 and 4212 are first coated with a layer 4223 of the release reagent, e.g., by spinning as discussed above. In FIG. 42B, a pre-manufactured valve is loaded into the recess 4210 of the anterior mold. Then both mold halves are spin-coated with silicone to create thin layers 4202 and 4203 of silicone over molds 4211 and 4212, respectively. In FIG. 42C, the two mold pieces are joined with alignment provided by the convex-concave matching contours. A mechanical force is applied to the mold and the pinch-off blade 4217 on the posterior mold, generating a clean cut of the silicone edge. The silicone in the mold is then cured by any suitable method, such as thermal curing, ultraviolet (UV) light exposure, or other methods. Finally, the fully formed silicone balloon 4214 with valve 4203 is released from the mold. Ideally, the silicone balloon has a clean-cut edge.

### Polar Cap Process

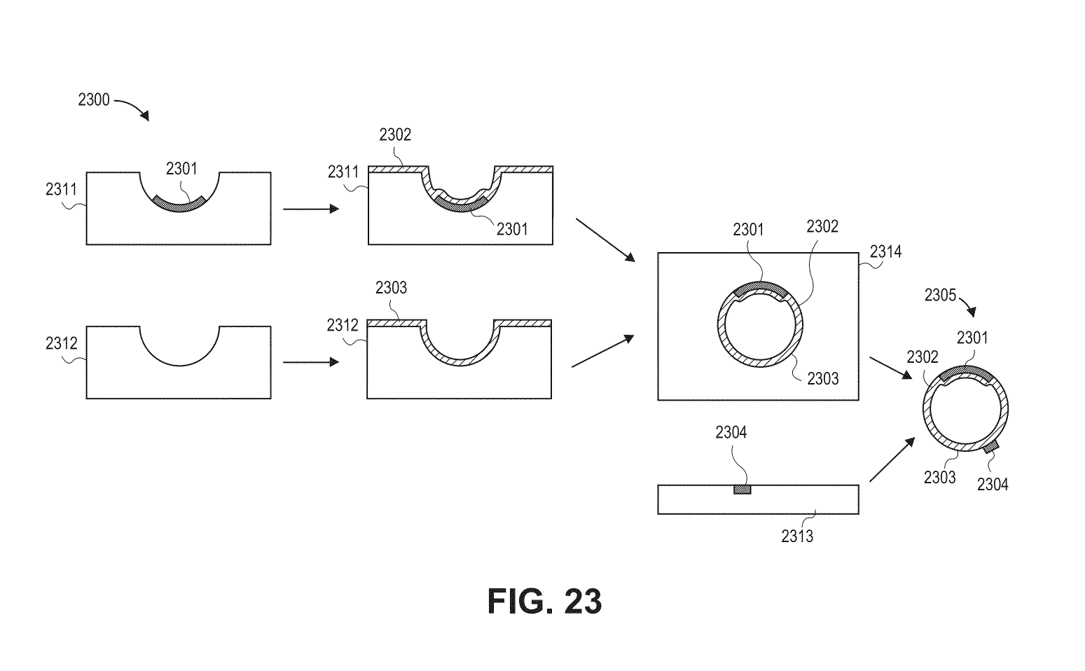

FIG. 23 illustrates manufacturing an additionally reinforced section of a lens membrane in accordance with an embodiment.

In some embodiments, a silicone intraocular lens manufacturing process creates an additionally reinforced section on a lens membrane. The enforced section can be the same silicone elastomer as the rest lens membrane, such as a more rigid silicone elastomer or a different, more flexible silicone elastomer.

In manufacturing process 2300, the reinforced section 2301 is fabricated by spin coating the silicone elastomer on the lens mold 2311 and then removing excessive silicone elastomer in unwanted areas. The reinforced section can be on the anterior side of the lens, on the posterior side of the lens, or on both sides of the lens. The coated silicone elastomer can be cured in an oven so to be partially solidified.

The following steps of the manufacturing process follow the similar process as described in FIG. 42. After the reinforced section 2301 is fabricated, the lens body is fabricated by spin coating silicone elastomer 2302 and 2303 on molds 2311 and 2312, respectively. One mold corresponds to the anterior half of the lens; the other mold corresponds to the posterior half of the lens.

After spin coating, the two halves 2311 and 2312 are clamped and fused together in device 2314 and placed in a convection oven to cure.

Microelectromechanical systems (MEMS) refill valve 2304 is fabricated by molding a colored silicone patch in a 250 μm thick SU8-100 mold 2313. Patch 2304 is peeled from the mold and attached to lens 2305 using adhesive. In the exemplary embodiment, it is attached to an anterior segment of the lens. The patch 2304 can also be attached to lens 2305 using adhesive to a posterior segment of the lens. After attaching the MEMS refill valve 2304 to the lens, an incision is made in the refill valve to allow silicone oil to be injected into the body of the lens after surgical implantation.

### Photographic Results

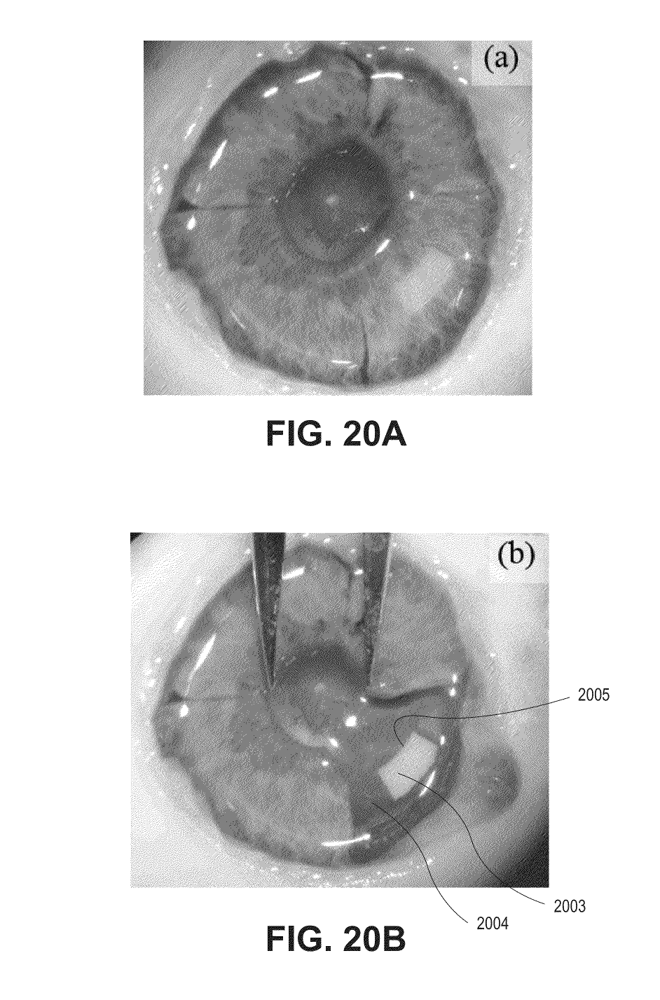

FIGS. 20A-20B are a picture of an intraocular lens implanted in a cadaver human eye in accordance with an embodiment. A rectangular patch valve is visible in the lower right quadrant of the eye in FIG. 20A. In FIG. 20B a section of the eye's iris is removed to show lens patch valve 2003 on intraocular lens 2004. Innermost edge 2005 is arcuate, following a constant radius around the center of the optical axis but set just beyond the optical path of the eye for a fully dilated pupil.

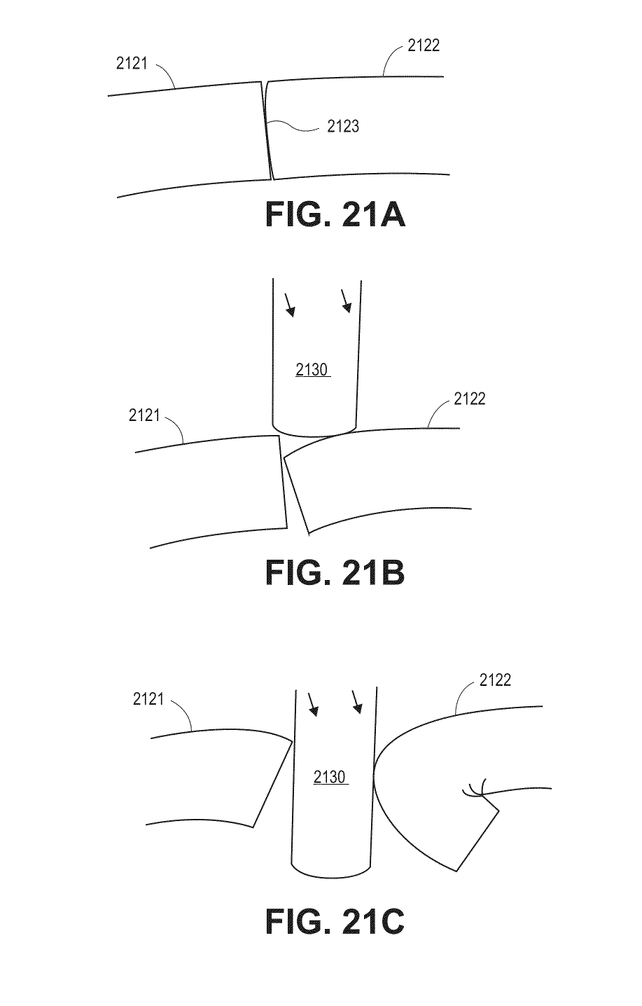

FIGS. 21A-21C are side elevation views of an intraocular lens patch with a pre-formed slit in accordance with an embodiment. Left side 2121 and right side 2122 of pre-formed slit 2123 are shown in a closed configuration in FIG. 21A. Fluid from below is sealed in by the patch because elastomeric stresses seal the slit tight. In FIG. 21B, needle 2130 begins to move down and, imperfectly to the left, against the slit to gain entry. Slit 2123 begins to open. In FIG. 21C, needle 2130 juts through the slit, bending left side 2121 and slightly crumpling elastomeric right side 2122. Sides 2121 and 2122 seal against the outside diameter of needle 2130, keeping fluid from inside the lens from leaking out.

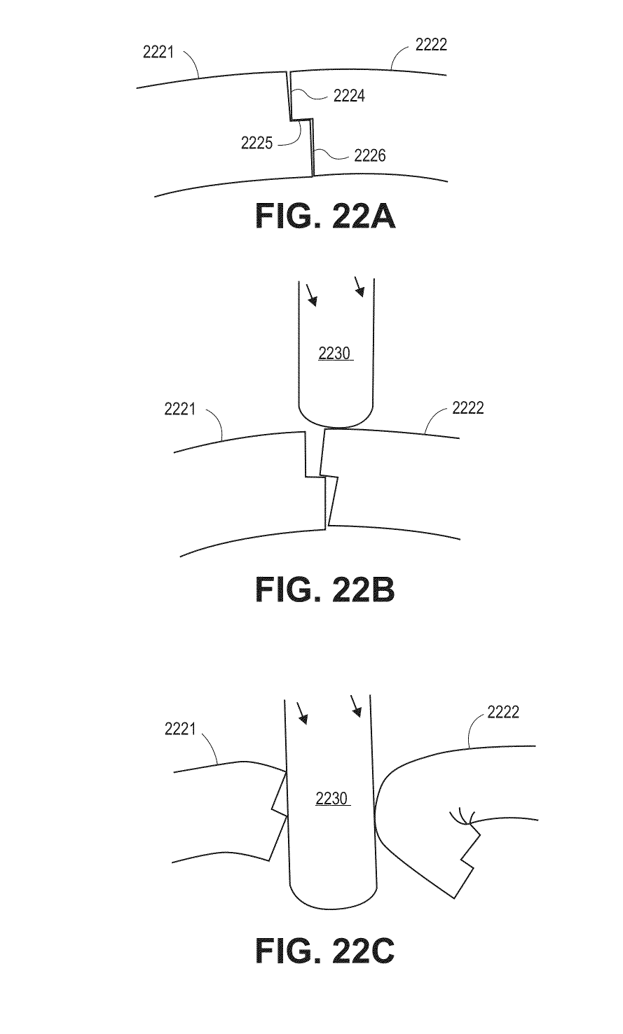

FIGS. 22A-22C are side elevation views of an intraocular lens patch with a stepped slit in accordance with an embodiment. Left side 2221 and right side 2222 of preformed slit 2224 are closed due to elastomeric stresses in FIG. 22A. Slit 2224 has shelf or stepped portion 2225, which joins slit 2224 with lower portion of slit 2226. The shelf is similar to using a needle to make an incision at an angle. In FIG. 22B, needle 2230 begins to move down and, imperfectly to the left, against the slit to gain entry to the lens. In FIG. 22C, needle 2230 just through the slit, bending left side 2221 and slightly crumpling elastomeric right side 2222. Sides 2221 and 2222 seal against the outside diameter of needle 2230, keeping fluid from inside the lens from leaking out.

It has been found that elastomeric patches of 25 μm, 100 μm, or greater are thick enough to self-close for many standard needles. A patch of 160 μm and thicker work with 362 μm diameter standard 28-gauge needles. A patch of 250 μm gives a factor of safety for the 28-gauge needle. This works for nominal pressures within the lens of under 1 psi, which change by 0.06 psi during accommodation.

A needle for injecting or removing fluid from the intraocular lens can be 908 μm diameter (20-gauge), 362 μm diameter (28-gauge), 311 μm diameter (30-gauge), 110 μm diameter (36-gauge), or other sizes. The smaller the needle to be used, the thinner the patch could be (as shown in FIG. 10).

A plurality of patches can be used to allow for multiple ports in the lens. One port can be used for filling or removing optically clear fluid from the lens, while another port can simultaneously remove air bubbles from an out-pocket.

### Countering Astigmatism or Other Aberrations

The valve and the surface profile of the lens can be used to adjust the optical aberration of the lens. This can be used to reduce total aberrations in the eye system (e.g. to cancel an aberration from the cornea), or to increase specific aberrations for optimal lens performance (e.g. increase spherical aberration to increase depth of field of the lens or create multiple focal points on the anterior surface of the lens). The surface profile can be adjusted by the altering the valve location, valve shape, the location of multiple valves, and the thickness profile of the lens wall. When the thickness profile of the lens wall is used, the maximum thickness of the thickest area of the wall can be 1000 microns, and preferably under 500 microns. In a preferred embodiment the maximum wall thickness in the thickened area is less than or equal to 200 microns.

To understand the mechanism of action creating a custom optical profile a coordinate system of the lens should be defined. The x-axis of the lens is defined as orthogonal to the optical axis (the z-axis) of the lens. The y-axis is orthogonal to both the x-axis and the z-axis. In this coordinate system, the x, y, and z axes are all orthogonal.

In certain embodiments, a valve portion of the lens causes a desired aberration in the lens. By making the valve an appropriate dimension, size, and/or location, it is possible to make the lens toric. In some embodiments, two or more valves are placed across from each other on the lens to create a toric shape. As an example, by placing two valves along the x-axis and on opposite sides of the optical axis of the lens it is possible to make the x-axis stiffer than the y-axis. When the lens is inflated the y-axis will deform more. This can be used to induce astigmatism in the lens relative to the valve position. In some embodiments, this technique is used to create a toric shaped surface on the anterior and/or posterior surfaces of the lens. The valve need not have a straight wall. In some embodiments, the valve thickness tapers as it moves to the edge. This tapering (or chamfer or fillet/round) allows for a more continuous change in curvature close to the valve.

The magnitude of the toric shape is a function of lens filling, valve distance from the center of the optical axis, the size and stiffness of the valve, and the configuration of the valve(s).

In some embodiments, the wall thickness or wall stiffness profile of the anterior or posterior portion of the lens is made to induce an aberration in the lens.

As an example, a thickened linear section along the x-axis of the lens on the anterior portion of the lens causes it to be stiffer along the x-axis than the y-axis of the lens. This can be used to create an aberration or a toric shape as described previously.

The thickened profile need not be a stepped section. In an embodiment, for a toric shape it is a smooth transition section from thin to thick in a manner that allows the optimum shape of the lens surface without sharp discontinuities. It is possible to model the appropriate profile for the desired optical outcome by using simulated or empirical analysis, such as finite element analysis, or experimental analysis coupled with an optical analysis. This includes modeling for the appropriate Zernicke coefficient, or aberrational profile of the lens. In other embodiments an annulus, or capped section of the lens is used to create the appropriate profile.

A similar result to lens thickness can be achieved by using a stiffer material along an axis of the lens, or with coating of a stiffer material, such as parylene. Stiffness can be adjusted by altering total thickness or Young's modulus of the entire wall. In certain embodiments this is a coating (e.g. parylene) with a higher or lower Young's modulus of the lens wall. In other embodiments two materials are used with different thicknesses or modulus of elasticity. The coating may have different thicknesses at different positions of the lens or may have a discrete pattern along the lens. In other renditions, the lens wall is made from more than one material, these materials having different mechanical properties (e.g. Young's modulus, Poisson ratio, density, permeability, yield strength, ultimate elongation).

In some embodiments, a profile of the anterior or posterior section of the lens is made to a specific lens thickness in order to induce or correct an aberration. In other embodiments, the anterior or posterior surfaces of the lens are manufactured to have multifocal elements, diffractive elements, or apodized elements. These elements can be rotationally symmetric around the optical axis of the lens. Stepped profiles may be used, with one side made with a multifocal optic such as a diffractive, or apodized optic. Multifocal optics may have different percentages of near or far light energy transmission based on the pupil size of the patient.

When elements are not rotationally symmetric they may need to be located relative to the eye. Therefore a mark on the lens allows angular identification of the lens (e.g. relative to the x and y axis). This allows the lens to be implanted and rotated into the correct location. In the preferred embodiment of the invention, the valve is used as a mark to indicate the angular position of the lens. The lens is implanted and the lens/valve combination is rotated so that the valve and lens are in the appropriate angular position. Or, they may be combined with an astigmatism reducing optical element such as a toric surface.

In some embodiments, the valve remains in a constant position relative to the eye, and any angular optical corrections on the lens are made relative to the valve. In this manner, the surgeon chooses the appropriate angular correction for each patient. The lens is implanted, and the valve remains in the same position for each patient. As an example, for a toric lens, the appropriate angle used to correct astigmatism is made relative to the valve for each specific lens. Therefore, one lens may correct 1 diopter of astigmatism with an axis at 10 degrees from the lens, while another would correct 1 diopter at an axis 45 degrees from the valve. The surgeon may allow for slight rotation of the lens after implantation for perfect alignment, but rotation would be limited in either direction. In one embodiment, the rotation would be limited to less than ±100 degrees (i.e., 100 degrees in each direction). This may allow surgical access to the valve because the valve is close to the incision site. In addition, by allowing some rotational motion of the valve, the number of lens designs can be reduced.

The invention has been described with reference to various specific and illustrative embodiments. However, it should be understood that many variations and modifications may be made while remaining within the spirit and scope of the following claims.

1. A method of manufacturing an elastomeric reservoir for a medical implant, the method comprising:
providing a pair of complementary platform structures each having a receiving surface;
applying a high-viscosity uncured elastomer to each of the receiving surfaces;
joining the platform structures to one another to form an cavity between the platform structures that is bounded by the receiving surfaces; and
curing the elastomer inside the cavity to form an elastomeric reservoir.

2. The method of claim 1 further comprising:
distributing the uncured elastomer uniformly over the receiving surfaces prior to the joining and the curing.

3. The method of claim 2 further comprising:
removing excess elastomer from at least one of the receiving surfaces after the distributing and before the joining.

4. (canceled)

5. The method of claim 1 wherein at least one of the platform structures includes a pinch-off blade configured for removing a protruding rim of elastomer upon joining of the platform structures.

6. The method of claim 1 wherein the elastomeric reservoir forms an intraocular lens, a breast implant, a testicular implant, balloon-type scleral buckle, or a gastric sleeve.

7. (canceled)

8. (canceled)

9. The method of claim 1 further comprising:
loading a pre-manufactured valve into a recess within one of the receiving surfaces.

10. The method of claim 9 wherein the pre-manufactured valve comprises a pre-cured or partially cured elastomer of a same material as the applied elastomer.

11. The method of claim 9 wherein the pre-manufactured valve has a thickness equal to a depth of the recess.

12. The method of claim 9 wherein the pre-manufactured valve has a thickness different from a depth of the recess.

13. The method of claim 9 further comprising:
loading a first portion of the valve into the recess prior to the applying; and
loading a second portion of the valve into the recess following the applying and prior to the curing.

14. (canceled)

15. (canceled)

16. (canceled)

17. The method of claim 1, wherein the platform structures include alignment features facilitating the joining.

18. (canceled)

19. The method of claim 1 further comprising:
fastening a pre-manufactured valve to a surface of the reservoir following the curing.

20. The method of claim 1 further comprising:
spinning the platform structures to distribute the uncured elastomer following the joining.

21. The method of claim 20 wherein the spinning includes off-axis, on-axis, or multiple-axis spinning.

22. (canceled)

23. The method of claim 1 further comprising:
applying a parylene layer to the elastomer following the curing of the elastomer.

24. (canceled)

25. The method of claim 1 further comprising:
adding one or more layers of fluorosilicone to the elastomer prior to or following the applying.

26. The method of claim 1 wherein the high-viscosity uncured elastomer has a viscosity over 6,000 centipose.

27. A method of manufacturing an accommodating intraocular lens apparatus, the method comprising:
placing at least one pre-manufactured silicone elastomeric valve, at least partially cured, on a first or a second lens mold;
spin coating the first lens mold and the second lens mold with an uncured silicone elastomer to form an anterior half of a lens on the first lens mold and a posterior half of a lens on the second lens mold, the lens configured for insertion into a capsular bag of an eye;
clamping the anterior and posterior halves of the lens together;
curing the anterior half, posterior half, and the valve together sufficient to fuse the anterior and posterior halves together and intimately attach the valve to the lens; and
removing the lens with the intimately-formed valve from the molds.

28-31. (canceled)

32. The method of claim 27 wherein the posterior half of the lens is manufactured with a series of discontinuous thicker sections from the mold for the posterior half of the lens, the thicker sections thereby being more resistant to an intensity of a laser than thinner sections.

33. (canceled)

34. The method of claim 27 wherein the silicone elastomeric valve has a thickness equal to or between 100 μm and 700 μm, thereby being thin enough to avoid contact with a posterior iris when implanted in an eye and sufficiently thick enough to self-seal needle punctures at nominal lens pressure for filling or adjusting optically clear medium within the lens.

35-60. (canceled)
